(19) United States
(12) Patent Application Publication
(10) Pub. No.: US 2003/0048732 A1
(43) Pub. Date: Mar. 13, 2003

(54) Disk drive

(75) Inventors: Masahiro Inata, Hyogo (JP); Yoshito Saji, Hyogo (JP); Teruyuki Takizawa, Osaka (JP); Kozo Ezawa, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: MATSUSHITA ELECTRIC INDUSTRIAL CO., LTD.

(21) Appl. No.: 10/242,534

(22) Filed: Sep. 12, 2002

(30) Foreign Application Priority Data
Sep. 13, 2001 (JP) 2001-277950

(51) Int. Cl. G11B 33/02

(52) U.S. Cl. 369/77.2

(57) ABSTRACT

A disk drive is loadable with either first or second cartridge in which a disk having a signal recording side is stored. In performing read and/or write operation(s), not only the distances between the signal recording side and the back surfaces of the first and second cartridges but also planar shapes of the first and second cartridges are different from each other. The disk drive includes a spindle motor with a turntable on which the disk is mounted and rotated, a read/write head for reading and/or writing a signal from/onto the signal recording side, and a supporting structure for supporting the back surface of the first or second cartridge at a vertical level, which is changeable with respect to the turntable according to the shape of the cartridge loaded, so that the disk is mounted on the turntable and that the signal is read and/or written from/on the disk.

### BACKGROUND OF THE INVENTION

1. Field of the Invention

The present invention relates to a disk drive that can be loaded with any of two or more types of cartridges with mutually different shapes in which a disk storage medium is stored in a rotatable state.

2. Description of the Related Art

Recently, various types of disk storage media, including optical discs and magnetic disks, have been further increasing their storage capacities. However, the higher the storage capacity of a disk storage medium, the more seriously the signal recording side of the disk is affected by some dirt such as dust deposited thereon. Accordingly, it has become more and more necessary to enhance the dustproofness of a cartridge that is used to store the storage medium therein.

For that reason, particularly when a disk storage medium is used within a dusty environment, the cartridge should be highly dustproof. Meanwhile, as various types of disk storage media are getting more and more popularized, their cartridges are increasingly required to reduce their prices.

However, a tradeoff is normally inevitable between these two requirements, and it is often difficult to make a cartridge that satisfies both requirements fully. Under the circumstances such as these, the user needs to prepare multiple types of cartridges with different shapes for disk storage media of the same type and pick one of them according to the intended application. Thus, the disk drive also needs to be compatible with those different types of cartridges. That is to say, the disk drive has to be loadable with any of those multiple types of cartridges appropriately to read or write information from/on the storage medium that is stored in the cartridge loaded.

Also, a number of different types of disk storage media, which comply with mutually different standards adopting various recording methods, have been developed and marketed recently. Accordingly, to store these different types of storage media, their cartridges should also be made to those different standards. For that reason, if a disk drive is compatible with just a cartridge that was made to a single set of specifications, then the user must prepare the same number of disk drives as the number of the cartridge standards available.

### SUMMARY OF THE INVENTION

In order to overcome the problems described above, preferred embodiments of the present invention provide a disk drive that can be loaded with any of mutually different types of cartridges to read or write information correctly from/on a disk that is stored in the cartridge loaded.

A disk drive according to a preferred embodiment of the present invention is preferably loadable with any of first and second cartridges, each storing a disk having a signal recording side. In performing read and/or write operation(s) on the disk, a distance between the signal recording side and a back surface of the first cartridge is different from a distance between the signal recording side and a back surface of the second cartridge, and a planar shape of the first cartridge is also different from that of the second cartridge. The disk drive preferably includes driving means, a read/write head and a supporting structure. The driving means preferably includes a mount plane on which the disk is mounted and rotated. The read/write head reads and/or writes a signal from/onto the signal recording side. The supporting structure preferably supports the back surface of the first or second cartridge at a vertical level, which is changeable with respect to the mount plane of the driving means according to the shape of the cartridge loaded, so that the disk is mounted on the mount plane and that the signal is read and/or written from/on the disk.

In one preferred embodiment of the present invention, the supporting structure preferably includes first and second bearing surfaces that contact with only the back surface of the first cartridge and only the back surface of the second cartridge, respectively, and are preferably located at mutually different vertical levels. When the first or second cartridge is loaded into the disk drive, one of the first and second bearing surfaces at the higher vertical level is preferably located under only the first cartridge or only the second cartridge.

In this particular preferred embodiment, the supporting structure preferably includes a regulating post having the first and second bearing surfaces. The regulating post preferably covers not only a region that is located under only the first or second cartridge but also a region that is located under each of the first and second cartridges when the first or second cartridge is loaded into the disk drive.

In another preferred embodiment of the present invention, the disk drive preferably further includes an actuator that is movable differently according to the shape of the cartridge being loaded into the disk drive. The supporting structure may include a bearing surface that is interlocked with the actuator so as to shift vertically to one of two different levels and support the back surface of the first or second cartridge loaded as the actuator moves.

In still another preferred embodiment, the supporting structure may include an actuator that is movable differently according to the shape of the cartridge being loaded into the disk drive and that has a bearing surface. The actuator may move in such a manner that when one of the first and second cartridges is loaded into the disk drive, the back surface of the cartridge loaded is supported by the bearing surface and that when the other cartridge is loaded into the disk drive, the back surface of the cartridge loaded does not contact with the bearing surface.

In this particular preferred embodiment, the supporting structure preferably includes a reference plane that is defined at a predetermined vertical level with respect to the mount plane of the driving means. When the other cartridge is loaded into the disk drive, the back surface of the cartridge loaded is preferably supported by the reference plane.

In yet another preferred embodiment, the disk drive may further include an actuator that is movable differently according to the shape of the cartridge being loaded into the disk drive. The supporting structure may have a bearing surface. The driving means and the read/write head may be interlocked with the actuator so as to shift to different vertical levels with respect to the bearing surface of the supporting structure as the actuator moves.

A disk drive according to another preferred embodiment of the present invention is also preferably loadable with any of first and second cartridges, each storing a disk with a signal recording side and having a pair of positioning holes on the back surface thereof. In performing read and/or write operation(s) on the disk, a distance between the center of the disk and a line that connects together the respective centers of the positioning holes of the first cartridge is different from a distance between the center of the disk and a line that connects together the respective centers of the positioning holes of the second cartridge, and a planar shape of the first cartridge is different from that of the second cartridge. The disk drive preferably includes driving means, a read/write head and a positioning structure. The driving means preferably includes a mount plane on which the disk is mounted and rotated. The read/write head reads and/or writes a signal from/onto the signal recording side. The positioning structure preferably includes a pair of positioning pins that engages with the positioning holes of the first or second cartridge loaded so that the first or second cartridge loaded is positioned on a plane that is parallel to the signal recording side of the disk.

In one preferred embodiment of the present invention, the disk drive preferably further includes an actuator that is movable differently according to the shape of the cartridge being loaded into the disk drive. The positioning pins may be interlocked with the actuator so as to move along with the actuator.

In this particular preferred embodiment, as the actuator moves, the positioning pins may move in a direction in which the first or second cartridge is loaded.

In an alternative preferred embodiment, as the actuator moves, the positioning pins may move vertically to the direction in which the first or second cartridge is loaded.

In another preferred embodiment, each of the positioning pins preferably includes a top to be inserted into associated one of the positioning holes, and a bearing surface that supports the back surface of the first or second cartridge loaded.

In still another preferred embodiment, the positioning structure may include a positioning base that supports the positioning pins thereon, and the actuator may move the positioning base with respect to the driving means.

In yet another preferred embodiment, the disk drive may further include an actuator that is movable differently according to the shape of the cartridge being loaded into the disk drive. The driving means and the read/write head may be interlocked with the actuator so as to move with respect to the positioning pins as the actuator moves.

A disk drive according to still another preferred embodiment of the present invention is also preferably loadable with any of first and second cartridges, each storing a disk with a signal recording side and having a pair of positioning holes on the back surface thereof. In performing read and/or write operation(s) on the disk, a distance between the center of the disk and a line that connects together the respective centers of the positioning holes of the first cartridge is different from a distance between the center of the disk and a line that connects together the respective centers of the positioning holes of the second cartridge, and a planar shape of the first cartridge is different from that of the second cartridge. The disk drive preferably includes driving means, a read/write head and a positioning structure. The driving means preferably includes a mount plane on which the disk is mounted and rotated. The read/write head reads and/or writes a signal from/onto the signal recording side. The positioning structure preferably includes: a first pair of positioning pins that engages with the pair of positioning holes of the first cartridge loaded; and a second pair of positioning pins that engages with the pair of positioning holes of the second cartridge so that the first or second cartridge loaded is positioned on a plane that is parallel to the signal recording side of the disk. The positioning structure preferably protrudes the first or second pair of positioning pins selectively by detecting the cartridge loaded as the first cartridge or the second cartridge according to the planar shape thereof.

A disk drive according to yet another preferred embodiment of the present invention is also preferably loadable with any of first and second cartridges, each storing a disk with a signal recording side and having a pair of positioning holes on the back surface thereof. A planar shape of the first cartridge is different from that of the second cartridge. The disk drive preferably includes driving means, a read/write head and a tray. The driving means preferably includes a mount plane on which the disk is mounted and rotated. The read/write head reads and/or writes a signal from/onto the signal recording side. The first or second cartridge is preferably mounted on the tray after having been positioned in such a manner that the center of the disk stored in the first cartridge mounted is aligned with that of the disk stored in the second cartridge mounted while the signal is read and/or written from/on the disk. Also, the tray is preferably used to insert or remove the first or second cartridge into/from the disk drive.

In one preferred embodiment of the present invention, the tray preferably includes a concave portion that stores at least a portion of each of the first and second cartridges. The side surfaces of the concave portion preferably include a first set of receiving surfaces that contacts with only side surfaces of the first cartridge and a second set of receiving surfaces that contacts with only side surfaces of the second cartridge.

In another preferred embodiment of the present invention, in performing read and/or write operation(s) on the disk, a distance between the signal recording side and a back surface of the first cartridge is different from a distance between the signal recording side and a back surface of the second cartridge. The tray preferably includes first and second bearing surfaces that contact with only the back surface of the first cartridge and only the back surface of the second cartridge, respectively, and are preferably located at mutually different vertical levels. When the first or second cartridge is loaded into the disk drive, one of the first and second bearing surfaces at the higher vertical level is preferably located under only the first cartridge or only the second cartridge.

In still another preferred embodiment, in performing read and/or write operation(s) on the disk, a distance between the center of the disk and a line that connects together the respective centers of the positioning holes of the first cartridge is different from a distance between the center of the disk and a line that connects together the respective centers of the positioning holes of the second cartridge. The tray preferably includes an actuator that is movable differently according to the shape of the cartridge being loaded into the disk drive and a positioning structure. The positioning structure preferably includes a pair of positioning pins and is preferably interlocked with the actuator so as to move in such a manner that the positioning pins thereof engage with the positioning holes of the first or second cartridge loaded.

In this particular preferred embodiment, each of the positioning pins preferably includes a top to be inserted into associated one of the positioning holes, and a bearing surface that contacts with the back surface of the first or second cartridge loaded.

In another preferred embodiment, the disk drive may further include a traverse chassis that supports the driving means thereon, and a pair of fixing pins that is provided for the traverse chassis. When the first or second cartridge being inserted on the tray reaches such a position that the center of the disk stored in the first or second cartridge is located over the center of the driving means, the traverse chassis may be raised to mount the disk on the mount plane.

More specifically, each of the positioning pins preferably includes first and second bottoms that are located at mutually different vertical levels with respect to the bearing surface, and first and second positioning holes that are provided on the first and second bottoms, respectively. The actuator preferably moves the positioning structure in such a manner that as the traverse chassis is raised, the fixing pins on the traverse chassis are selectively engaged with either the first positioning holes or the second positioning holes of the positioning pins.

A disk drive according to yet another preferred embodiment of the present invention is also loadable with any of first and second cartridges, each storing a disk with a signal recording side. One of the first and second cartridges preferably includes an internal clamper, while the other cartridge preferably has a clamper mount space on the upper surface thereof. The disk drive preferably includes driving means, a read/write head, a clamper, and sensor means. The driving means preferably includes a mount plane on which the disk is mounted and rotated. The read/write head reads and/or writes a signal from/onto the signal recording side. The clamper preferably sandwiches and holds the disk between the clamper and the mount plane of the driving means. The sensor means preferably senses whether the first or second cartridge loaded has the clamper mount space on the upper surface thereof. The clamper mount space includes a position at which the clamper of the disk drive is located in holding the disk thereon. When the sensor means senses that the cartridge loaded has the clamper mount space, the disk drive mounts the clamper thereof onto the disk.

In one preferred embodiment of the present invention, the disk drive preferably further includes a clamper supporter, which supports the clamper of the disk drive thereon and which is held so as to be rotatable at one end thereof. When the sensor means senses that the cartridge loaded has the clamper mount space, the clamper supporter is preferably rotated to mount the clamper of the disk drive onto the disk.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIGS. 1A and 1B are respectively a cross-sectional view and a plan view of a first cartridge for use in a first specific preferred embodiment of the present invention.

FIGS. 2A and 2B are respectively a cross-sectional view and a plan view of a second cartridge for use in the first preferred embodiment.

FIG. 3 is a perspective view illustrating a disk drive according to the first preferred embodiment.

FIGS. 4A and 4B are respectively a plan view and a cross-sectional view illustrating a state where the first cartridge shown in FIGS. 1A and 1B has been loaded into the disk drive shown in FIG. 3.

FIGS. 5A and 5B are respectively a plan view and a cross-sectional view illustrating a state where the second cartridge shown in FIGS. 2A and 2B has been loaded into the disk drive shown in FIG. 3.

FIGS. 6A and 6B are respectively a cross-sectional view and a plan view of a second cartridge for use in a second specific preferred embodiment of the present invention.

FIG. 7 is a perspective view illustrating a disk drive according to the second preferred embodiment.

FIGS. 8A and 8B are respectively a plan view and a cross-sectional view illustrating a state where the first cartridge shown in FIGS. 1A and 1B has been loaded into the disk drive shown in FIG. 7.

FIGS. 9A and 9B are respectively a plan view and a side view illustrating a state where the second cartridge shown in FIGS. 6A and 6B has been loaded into the disk drive shown in FIG. 7.

FIGS. 10A and 10B are respectively a cross-sectional view and a plan view of a second cartridge for use in a third specific preferred embodiment of the present invention.

FIG. 11A is a cross-sectional view illustrating a state where the first cartridge shown in FIGS. 1A and 1B has been loaded into a disk drive according to the third preferred embodiment.

FIG. 11B is a cross-sectional view illustrating a state where the second cartridge shown in FIGS. 10A and 10B has been loaded into the disk drive of the third preferred embodiment.

FIG. 12A is a plan view illustrating a state where the first cartridge shown in FIGS. 1A and 1B has been loaded into the disk drive of the third preferred embodiment.

FIG. 12B is a plan view illustrating a state where the second cartridge shown in FIGS. 10A and 10B has been loaded into the disk drive of the third preferred embodiment.

FIG. 13 is a perspective view illustrating a disk drive according to a fourth specific preferred embodiment of the present invention.

FIG. 14 is a plan view illustrating a state where the first cartridge shown in FIGS. 1A and 1B has been loaded into the disk drive of the fourth preferred embodiment.

FIG. 15 is a plan view illustrating a state where the second cartridge shown in FIGS. 10A and 10B has been loaded into the disk drive of the fourth preferred embodiment.

FIG. 16 is a perspective view illustrating a first cartridge for use in a fifth specific preferred embodiment of the present invention.

FIGS. 17A and 17B are respectively a plan view and a cross-sectional view of the first cartridge for use in the fifth preferred embodiment.

FIG. 18 is a perspective view illustrating a second cartridge for use in the fifth preferred embodiment.

FIGS. 19A and 19B are respectively a plan view and a cross-sectional view of the second cartridge for use in the fifth preferred embodiment.

FIG. 20 is a perspective view illustrating a third cartridge for use in the fifth preferred embodiment.

FIGS. 21A and 21B are respectively a plan view and a cross-sectional view of the third cartridge for use in the fifth preferred embodiment.

FIG. 22 is a perspective view illustrating a disk drive according to the fifth preferred embodiment.

FIGS. 23A and 23B are respectively a plan view and a cross-sectional view illustrating a state where the first cartridge shown in FIGS. 16, 17A and 17B has been loaded into the disk drive shown in FIG. 22.

FIG. 24 is a cross-sectional view illustrating a relationship between a positioning pin and a fixing pin in the situation where the first cartridge shown in FIGS. 16, 17A and 17B is loaded into the disk drive shown in FIG. 22.

FIGS. 25A and 25B are respectively a plan view and a cross-sectional view illustrating a state where the second cartridge shown in FIGS. 18, 19A and 19B has been loaded into the disk drive shown in FIG. 22.

FIG. 26 is a cross-sectional view illustrating a relationship between the positioning pin and the fixing pin in the situation where the second cartridge shown in FIGS. 18, 19A and 19B is loaded into the disk drive shown in FIG. 22.

FIGS. 27A and 27B are plan views illustrating a modified structure for the tray of the disk drive shown in FIG. 22.

FIGS. 28A and 28B are plan views illustrating another modified structure for the tray of the disk drive shown in FIG. 22.

FIG. 29 is a plan view illustrating a modified structure for the actuator of the disk drive shown in FIG. 22.

FIG. 30 is a plan view illustrating the position of a sensor lever in the disk drive shown in FIG. 22.

FIGS. 31A, 31B and 31C are cross-sectional views illustrating how the first cartridge shown in FIGS. 16, 17A and 17B is loaded into the disk drive shown in FIG. 22 wherein:

FIG. 31A illustrates a state where the tray is going to be inserted into the disk drive;

FIG. 31B illustrates a state where the tray has been inserted into the disk drive; and

FIG. 31C illustrates a state where a disk has been mounted on a turntable.

FIGS. 32A, 32B and 32C are cross-sectional views illustrating how the second cartridge shown in FIGS. 18, 19A and 19B is loaded into the disk drive shown in FIG. 22 wherein:

FIG. 32A illustrates a state where the tray is going to be inserted into the disk drive;

FIG. 32B illustrates a state where the tray has been inserted into the disk drive; and

FIG. 32C illustrates a state where the disk has been mounted on the turntable.

FIGS. 33A, 33B and 33C are cross-sectional views illustrating how the third cartridge shown in FIGS. 20, 21A and 21B is loaded into the disk drive shown in FIG. 22 wherein:

FIG. 33A illustrates a state where the tray is going to be inserted into the disk drive;

FIG. 33B illustrates a state where the tray has been inserted into the disk drive; and

FIG. 33C illustrates a state where the disk has been mounted on the turntable.

### DETAILED DESCRIPTION OF PREFERRED EMBODIMENTS

Embodiment 1

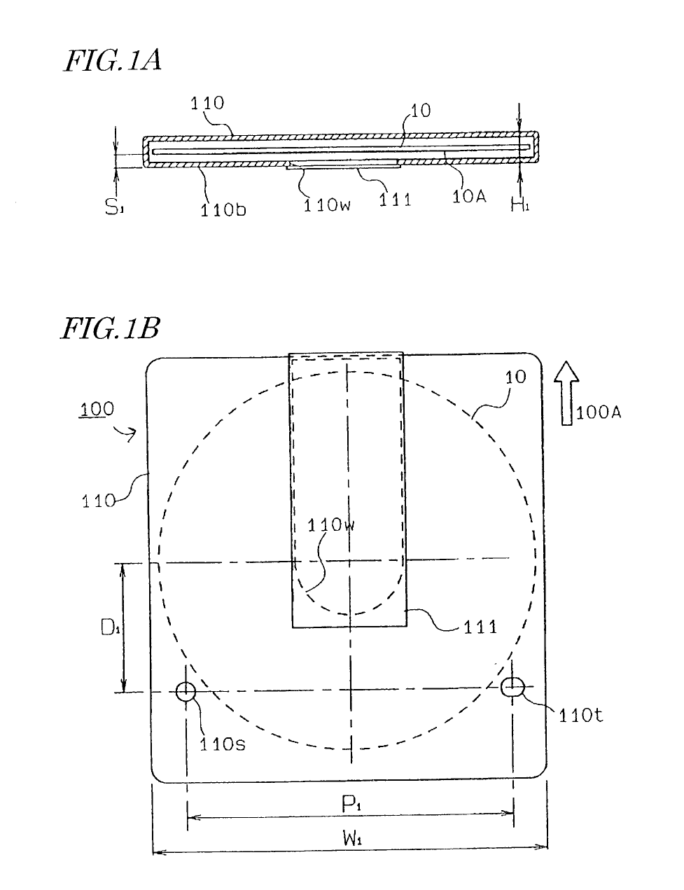

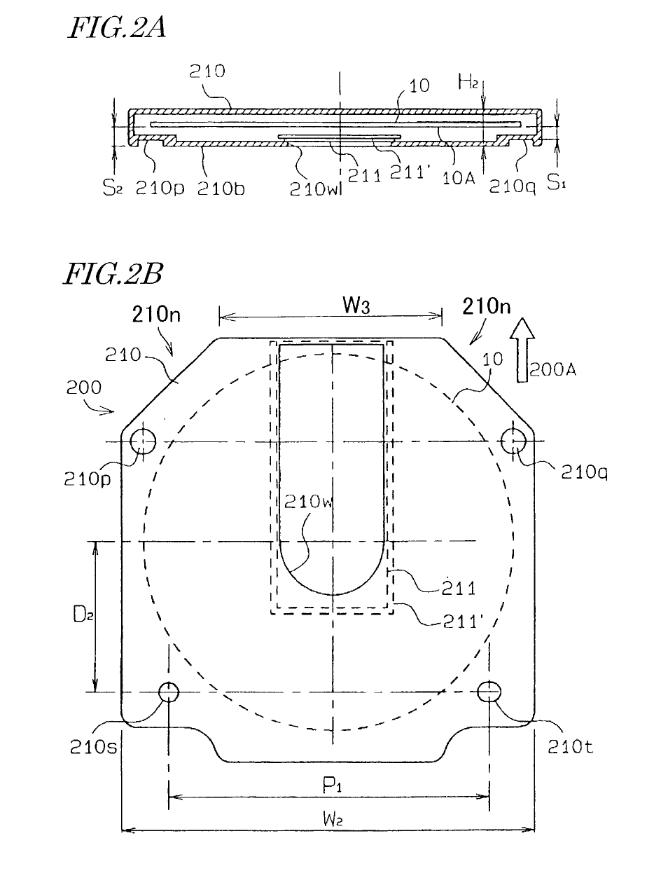

Hereinafter, a disk drive according to a first specific preferred embodiment of the present invention will be described. First, two types of cartridges to be selectively loaded into the disk drive of the first preferred embodiment will be described with reference to FIGS. 1A, 1B, 2A and 2B.

FIG. 1A is a cross-sectional view illustrating a first cartridge 100 and FIG. 1B is a plan view of the first cartridge 100 as viewed from over the back surface thereof. The first cartridge 100 shown in FIGS. 1A and 1B is a relatively thin popular version that was made at a low manufacturing cost to cut down its price.

On the other hand, FIG. 2A is a cross-sectional view illustrating a second cartridge 200 and FIG. 2B is a plan view of the second cartridge 200 as viewed from over the back surface thereof. The second cartridge 200 shown in FIGS. 2A and 2B is a relatively stiff and highly dustproof version for business use.

As shown in FIGS. 1A and 1B, the first cartridge 100 includes a cartridge body 110 for storing a disk 10 therein. The cartridge body 110 includes a window 110w on the back surface 110b thereof to allow a member for rotating the disk 10 (e.g., a spindle motor) and a read/write head to enter the cartridge body 110 and access the disk 10. Also, a shutter 111 for opening or closing the window 110w is externally provided on the back surface 110b of the cartridge body 110. That is to say, while the shutter 111 is open, the signal recording side 10A of the disk 10 is partially exposed inside the window 110w.

The first cartridge 100 (or the cartridge body 110 thereof in this case) has a thickness H₁. While the disk 10 is held inside the cartridge body 110 so as to be rotatable therein, the distance between the back surface 110b of the cartridge body 110 and the signal recording side 10A of the disk 10 is S₁. Also, the first cartridge 100 is inserted into a disk drive (not shown) in the direction indicated by the arrow 100A in FIG. 1B. The width of the first cartridge 100 as measured vertically to the inserting direction 100A is W₁.

The cartridge body 110 includes positioning holes 110s and 110t that are provided to define the position of the cartridge 100 inside the disk drive. Of these two positioning holes 110s and 110t, the positioning hole 110t defines the position of the cartridge 100 in the direction vertical to the direction 100A. The distance between the centers of the two positioning holes 110s and 110t is P₁. Also, the distance between the center of the disk 10 and a line that connects together the respective centers of the positioning holes 110s and 110t is D₁.

As shown in FIGS. 2A and 2B, the second cartridge 200 includes a cartridge body 210 for storing the disk 10 therein. The cartridge body 210 includes a window 210w on the back surface 210b thereof to allow a member for rotating the disk 10 (e.g., a spindle motor) and a read/write head to enter the cartridge body 210 and access the disk 10. Unlike the first cartridge 100, the second cartridge 200 includes two shutters 211 and 211′ inside the cartridge body 210 to open and close the window 210w. In such a structure, it is possible to further reduce the amount of dust that enters the cartridge body 210 through the window 210w and thereby enhance the dustproofness of the cartridge 200. While the shutters 211 and 211′ are open, the signal recording side 10A of the disk 10 is partially exposed inside the window 210w. The cartridge body 210 includes notches 210n at two of the four corners thereof near the window 210w. Since the notches 210n are provided, one side of the cartridge body 210 that is adjacent to the window 210w has a width W₃, which is smaller than the width W₁ of the first cartridge 100.

The second cartridge 200 has a thickness H₂. As described above, the second cartridge 200 has a highly dustproof structure and has its stiffness increased by increasing the thicknesses of respective portions of the cartridge body 210. Thus, the thickness H₂ of the second cartridge 200 is greater than the thickness H₁ of the first cartridge 100. Accordingly, while the disk 10 is held inside the cartridge body 210 so as to be rotatable therein, the distance S₂ between the back surface 210b of the cartridge body 210 and the signal recording side 10A of the disk 10 is also longer than the distance S₁ of the first cartridge 100.

The second cartridge 200 is inserted into a disk drive (not shown) in the direction indicated by the arrow 200A in FIG. 2B. The width W₂ of the second cartridge 200 as measured vertically to the inserting direction 200A is greater than the width W₁ of the first cartridge 100.

The cartridge body 210 also includes positioning holes 210s and 210t that are provided to define the position of the cartridge 200 inside the disk drive. Of these two positioning holes 210s and 210t, the positioning hole 210t defines the position of the cartridge 200 in the direction vertical to the direction 200A. As in the first cartridge 100, the distance between the centers of the two positioning holes 210s and 210t is P₁. However, the distance between the center of the disk 10 and the line that connects together the respective centers of the positioning holes 210s and 210t is D₂, which is longer than the distance D₁ of the first cartridge 100.

Furthermore, the back surface 210b of the cartridge body 210 includes two concave portions, of which the bottoms are reference planes 210p and 210q, respectively. The distance between the reference plane 210p or 210q and the signal recording side 10A of the disk 10 is S₁, which is equal to the distance S₁ between the back surface 110b of the cartridge body 110 and the signal recording side 10A of the disk 10 in the first cartridge 100.

As described above, the first cartridge 100 has a simplified shutter structure, and is a small-sized lightweight cartridge that can be manufactured at a relatively low cost. In contrast, the second cartridge 200 has a double shutter structure and the respective portions of the cartridge body 210 thereof are relatively thick. Accordingly, the second cartridge 200 is highly stiff and dustproof and is greater in outer dimensions than the first cartridge 100.

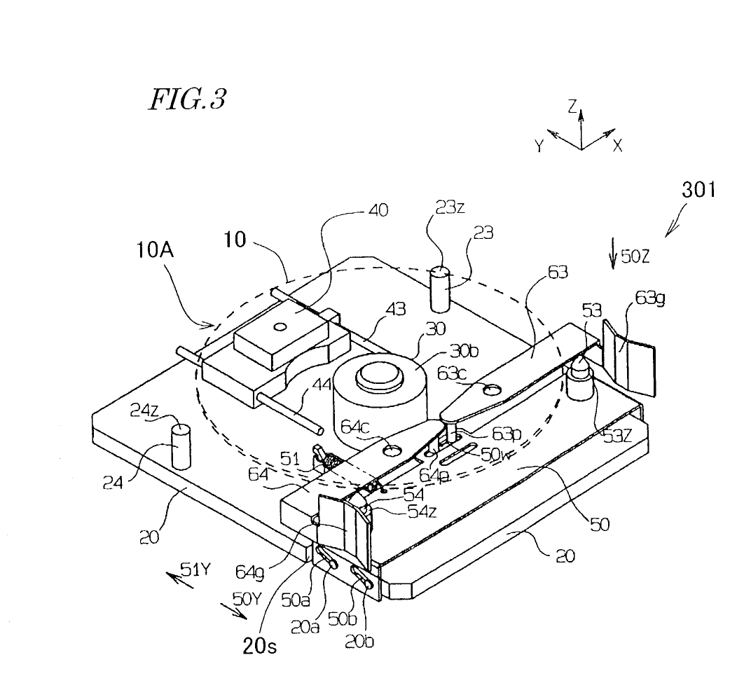

Next, a disk drive 301 that can be loaded with any of the first and second cartridges 100 and 200 will be described. As shown in FIG. 3, the disk drive 301 includes a traverse chassis 20, a spindle motor 30 as a driving means, and an optical pickup 40 as a read/write head.

The spindle motor 30 includes a turntable 30b (i.e., a disk mount plane) for mounting the disk 10 thereon, and is secured to the traverse chassis 20. The optical pickup 40 is supported on the traverse chassis 20 so as to be movable on guide shafts 43 and 44. Also, two regulating posts 23 and 24 are provided on the traverse chassis 20 and have bearing surfaces 23z and 24z as their upper surfaces. By getting either the back surface 110b of the first cartridge 100 or the reference planes 210p and 210q of the second cartridge 200 received by the bearing surfaces 23z and 24z, the first or second cartridge 100 or 200 can be positioned at an appropriate height with respect to the spindle motor 30 and the optical pickup 40.

As will be described in detail later, when the first or second cartridge 100 or 200 in which the disk 10 is stored is loaded into the disk drive 301, the turntable 30b enters the first or second cartridge 100 or 200 through the window 110w or 210w of the first or second cartridge 100 or 200 to hold the disk 10 thereon. Then, while getting the disk 10 rotated by the spindle motor 30, the optical pickup 40 accesses the signal recording side 10A of the disk 10 through the window 110w or 210w to read or write a signal from/on the signal recording side 10A.

The disk drive 301 further includes a positioning base 50. The positioning base 50 extends vertically to the cartridge inserting direction (i.e., Y direction), and both ends thereof are bent downward so as to be parallel to the side surfaces of the traverse chassis 20. These two downwardly bent ends of the positioning base 50 are provided with holes 50a, 50b, 50c and 50d. On the other hand, the two side surfaces of the traverse chassis 20 are provided with pins 20a, 20b, 20c and 20d that engage with the holes 50a, 50b, 50c and 50d of the positioning base 50, respectively. Thus, the positioning base 50 moves with respect to the traverse chassis 20 in the Y and Z directions so that the pins 20a, 20b, 20c and 20d of the traverse chassis 20 move along the holes 50a, 50b, 50c and 50d of the positioning base 50, respectively. As used herein, X, Y and Z directions are defined to be a direction that is parallel to the longer sides of the positioning base 50, a direction that is parallel to the two side surfaces of the traverse chassis 20 with the pins 20a, 20b, 20c and 20d and vertical to the X direction, and a direction that is vertical to both the X and Y directions, respectively.

The positioning base 50 is further provided with positioning pins 53 and 54. The respective tops of the positioning pins 53 and 54 have such shapes as to be insertable into the positioning holes 110s and 110t of the first cartridge 100 or the positioning holes 210s and 210t of the second cartridge 200. The positioning pins 53 and 54 include bearing surfaces 53z and 54z near their tops. The tops of the positioning pins 53 and 54 are inserted into the positioning holes 110s and 110t or 210s and 210t until the bearing surfaces 53z and 54z contact with the back surface 110b of the first cartridge 100 or the back surface 210b of the second cartridge 200.

By getting the tops of the positioning pins 53 and 54 inserted into the positioning holes 110s and 110t of the first cartridge 100 or the positioning holes 210s and 210t of the second cartridge 200, the position of the first or second cartridge 100 or 200 on an X-Y plane is defined with respect to the disk drive 301. Also, when the bearing surfaces 53z and 54z are brought into contact with the back surface 110b of the first cartridge 100 or the back surface 210b of the second cartridge 200, the position of the first or second cartridge 100 or 200 in the Z direction (i.e., the thickness direction of the cartridge 100 or 200) is defined with respect to the disk drive 301.

The disk drive 301 further includes actuators 63 and 64. These actuators 63 and 64 have shapes that are symmetrical about the centerline of the disk drive 301 that passes the center of the spindle motor 30 and are supported on the traverse chassis 20 so as to be rotatable on their shafts 63c and 64c, respectively. A guide 63g, which is located near one side surface of the traverse chassis 20, is provided for one end of the actuator 63, while a guide 64g, which is located near the opposite side surface of the traverse chassis 20, is provided for one end of the actuator 64. The other end of the actuator 63 includes a pin 63p and the other end of the actuator 64 includes a pin 64p. These pins 63p and 64p engage with an elongated hole 50w of the positioning base 50.

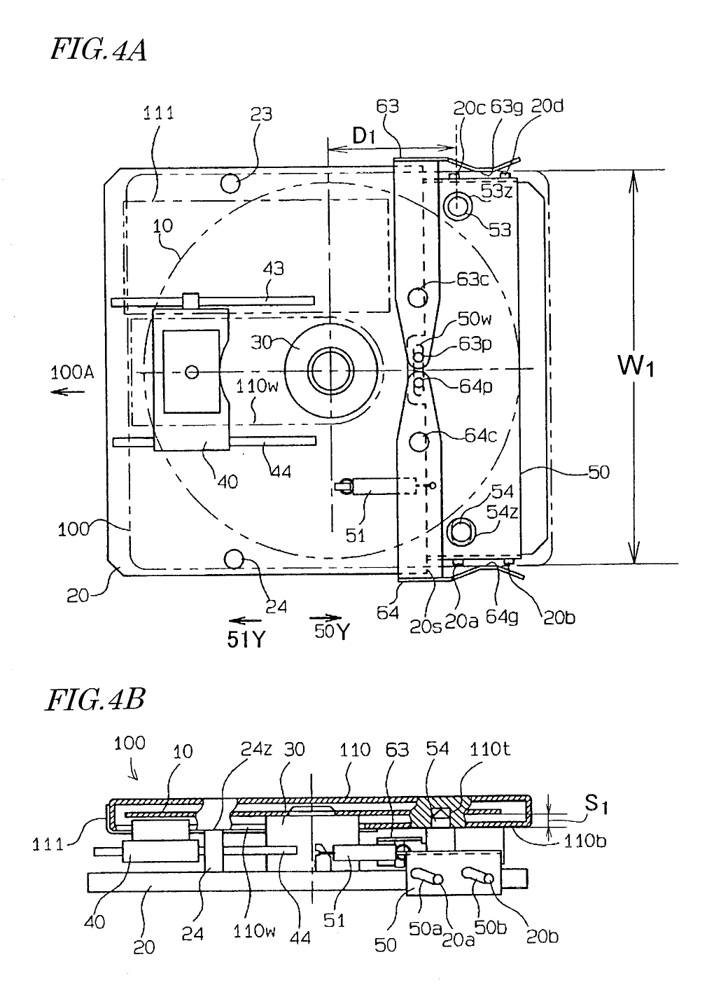

As shown in FIGS. 4A and 4B, a spring 51 applies an elastic force to the positioning base 50 in the direction indicated by the arrow 51Y and is normally in contact with, and stopped by, the stopper 20s of the traverse chassis 20. In this state, the vertical level (i.e., the height as measured in the Z direction) of the bearing surfaces 53z and 54z of the positioning pins 53 and 54 is lower than that of the turntable 30b by S₁ as shown in FIG. 4B. Also, the distance between the center of rotation of the spindle motor 30 and the line that connects together the respective centers of the positioning pins 53 and 54 as measured in the Y direction is D₁ as shown in FIG. 4A. Furthermore, in this state, the distance between the two guides 63g and 64g is W₁, which is equal to the width W₁ of the first cartridge 100. Accordingly, while the first cartridge 100 is being inserted into this disk drive 301, the actuators 63 and 64 do not rotate.

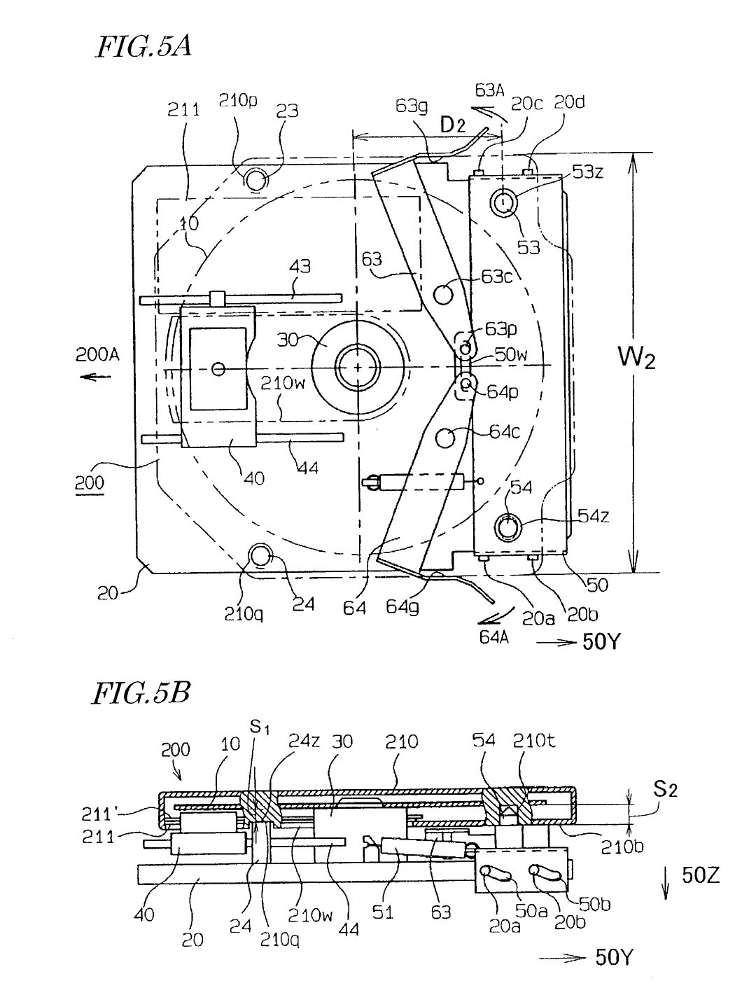

On the other hand, while the second cartridge 200 is being inserted into the disk drive 301, these guides 63g and 64g are pressed by the second cartridge 200 and the actuators 63 and 64 are rotated to such a degree that the distance between the guides 63g and 64g gets equal to the width W₂ of the second cartridge 200 as shown in FIG. 5A. As a result, the pins 63p and 64p moves the positioning base 50 in the direction 50Y and in the Z direction as shown in FIGS. 5A and 5B. In such a state, the vertical level of the bearing surfaces 53z and 54z of the positioning pins 53 and 54 is lower than that of the turntable 30b by S₂ as shown in FIG. 5B. Also, the distance between the center of rotation of the spindle motor 30 and the line that connects together the respective centers of the positioning pins 53 and 54 as measured in the Y direction is D₂ as shown in FIG. 5A.

Although not shown in FIG. 3, the disk drive 301 further includes an insertion slot and an inserting/ejecting mechanism for use to insert the first or second cartridge 100 or 200 into the disk drive 301. The insertion slot and the inserting/ejecting mechanism are provided near the actuators 63 and 64. After having been inserted into the disk drive 301 through the insertion slot, the first or second cartridge 100 or 200 is moved in the direction 51Y either by an auto-loading mechanism, which forms part of the inserting/ejecting mechanism, or manually, and then a force is applied downward from the inserting/ejecting mechanism to the first or second cartridge 100 or 200 in the direction 50Z. As a result, the first or second cartridge 100 or 200 is guided to a predetermined load position inside the disk drive 301 and the disk 100 that is stored in the first or second cartridge 100 or 200 is mounted on the turntable 30b of the spindle motor 30.

The first or second cartridge 100 or 200 loaded may be ejected from the disk drive 301 in the following manner. First, an eject lever (not shown) is depressed to make the inserting/ejecting mechanism (not shown) lift the cartridge upward (i.e., in the direction opposite to the direction 50Z). Thereafter, the first or second cartridge 100 or 200 is moved in the direction 50Y so as to be ejected at least partially through the insertion slot. Such an inserting/ejecting mechanism may be any of known inserting/ejecting mechanisms for use in a floppy disk drive or an MD drive. The disk drives according to second, third and fourth preferred embodiments of the present invention to be described later also includes similar insertion slot and inserting/ejecting mechanism although the description thereof will be omitted herein.

Hereinafter, it will be described exactly how the disk drive 301 is loaded with the first or second cartridge 100 or 200.

FIGS. 4A and 4B are respectively a plan view and a cross-sectional view illustrating a state where the first cartridge 100 has been loaded into the disk drive 301.

As described above, in a normal state, an elastic force is applied from the spring 51 to the positioning base 50 in the direction 51Y and the positioning base 50 is in contact with the stopper 20s of the traverse chassis 20. In this state, the distance between the guides 63g and 64g is approximately equal to W₁ as shown in FIG. 4A.

Suppose the first cartridge 100 is inserted into the disk drive 301 in the direction 100A. In that case, since the width of the first cartridge 100 is W₁, the guides 63g and 64g of the actuators 63 and 64 allow the first cartridge 100 being inserted to go deeper into the disk drive 301 without moving from their home positions.

During this loading operation, the actuators 63 and 64 do not move at all, neither does the positioning base 50. Accordingly, the distance between the line that connects together the respective centers of the positioning pins 53 and 54 and the center of the spindle motor 30 is equal to D₁, and the distance (or the difference in vertical level) between the bearing surfaces 53z and 54z of the positioning pins 53 and 54 and the turntable 30b (which is as high as the signal recording side 10A of the disk 10) is S₁.

While the first cartridge 100 is being inserted in the direction 100A, the shutter opening/closing mechanism (not shown) of the disk drive 301 opens the shutter 111 of the first cartridge 100. And when the first cartridge 100 being inserted reaches a position where the positioning holes 110s and 110t thereof are located over the positioning pins 53 and 54, the positioning pins 53 and 54 engage with the positioning holes 110s and 110t, respectively. In this manner, the position of the first cartridge 100 on the X-Y plane is defined. As described above, the distance between the line that connects together the respective centers of the positioning pins 53 and 54 and the center of the spindle motor 30 is D₁, which is equal to the distance between the line that connects together the respective centers of the positioning holes 110s and 110t of the first cartridge 100 and the center of the disk 10 stored in the first cartridge 100. Thus, the center of the disk 10 that is stored in the first cartridge 100 is aligned with the center of the spindle motor 30.

Also, at this point in time, the bearing surfaces 23z and 24z of the regulating posts 23 and 24 contact with the back surface 110b of the first cartridge 100 and the bearing surfaces 53z and 54z of the positioning pins 53 and 54 also contact with the back surface 110b. As a result, the position of the first cartridge 100 in the thickness direction (i.e., vertical level thereof) is defined. As described above, the vertical level difference between the bearing surfaces 53z and 54z of the positioning pins 53 and 54 and the turntable 30b is S₁, which is equal to the vertical level difference between the back surface 110b of the first cartridge 100 and the signal recording side 10A of the disk 10 that is stored in the first cartridge 100. Thus, the disk 10 can be mounted on the turntable 30b just as intended. In this manner, the first cartridge 100 can be accurately positioned with respect to, and loaded into, the disk drive 301 and the disk 10 can be appropriately mounted on the turntable 30b. Then, the optical pickup 40 can enter the first cartridge 100 through the window 110w and access the signal recording side 10A of the disk 10 to read or write a signal from/on the signal recording side 10A.

FIGS. 5A and 5B are respectively a plan view and a cross-sectional view illustrating a state where the second cartridge 200 has been loaded into the disk drive 301.

While the disk drive 301 is in its initial state, the distance between the guides 63g and 64g is approximately W₁, which is the width of the first cartridge 100. On the other hand, the second cartridge 200 includes the notches 210n at the two corners thereof near its window 210w. Accordingly, the width of the cartridge body 210 thereof changes from W₃ into W₂ at the end thereof. Since W₃<W₁<W₂, the notched end portion of the second cartridge 200 is inserted into the disk drive 301 without contacting with the guide 63g or 64g.

However, as the second cartridge 200 is inserted deeper into the disk drive 301, the guides 63g and 64g soon contact with, and are pressed by, the non-notched side surfaces of the second cartridge 200. As a result, on a plane parallel to the signal recording side 10A of the disk 10, the actuators 63 and 64 rotate on the shafts 63c and 64c toward the directions indicated by the arrows 63A and 64A, respectively. Meanwhile, the pins 63p and 64p of the actuators 63 and 64 press the positioning base 50 in the direction 50Y.

As a force is applied from the pins 63p and 64p to the positioning base 50 in the direction 50Y, the positioning base 50 moves with respect to the traverse chassis 20 so that the pins 20a, 20b, 20c and 20d of the traverse chassis 20 move along the holes 50a, 50b, 50c and 50d of the positioning base 50, respectively. As shown in FIG. 5B, each of the holes 50a, 50b, 50c and 50d extends diagonally with respect to the directions 50Y and 50Z so as to have components in the directions 50Y and 50Z. Accordingly, the positioning base 50 moves in the directions 50Y and 50Z with respect to the traverse chassis 20. As a result, the distance between the line that connects together the respective centers of the positioning pins 53 and 54 and the center of the spindle motor 30 becomes D₂, which is equal to the distance between the line that connects together the respective centers of the positioning holes 210s and 210t of the second cartridge 200 and the center of the disk 10 that is stored in the second cartridge 200. Also, the vertical level difference between the bearing surfaces 53z and 54z of the positioning pins 53 and 54 and the turntable 30b (which is as high as the signal recording side 10A of the disk 10) becomes S₂, which is equal to the vertical level difference between the back surface 210b of the second cartridge 200 and the signal recording side 10A of the disk 10 that is stored in the second cartridge 200.

When the second cartridge 200 being inserted reaches a position where the positioning holes 210s and 210t thereof are located over the positioning pins 53 and 54, the positioning pins 53 and 54 engage with the positioning holes 210s and 210t, respectively. In this manner, the position of the second cartridge 200 on the X-Y plane is defined. As described above, the distance between the line that connects together the respective centers of the positioning pins 53 and 54 and the center of the spindle motor 30 is D₂, which is equal to the distance between the line that connects together the respective centers of the positioning holes 210s and 210t of the second cartridge 200 and the center of the disk 10 stored in the second cartridge 200. Thus, the center of the disk 10 that is stored in the second cartridge 200 can be aligned with the center of the spindle motor 30.

Also, at this point in time, the bearing surfaces 23z and 24z of the regulating posts 23 and 24 contact with the reference planes 210p and 210q of the second cartridge 200, and the bearing surfaces 53z and 54z of the positioning pins 53 and 54 contact with the back surface 210b of the second cartridge 200. As a result, the position of the second cartridge 200 in the thickness direction (i.e., vertical level thereof) is defined. As described above, the vertical level difference between the bearing surfaces 53z and 54z of the positioning pins 53 and 54 and the turntable 30b is S₂, which is equal to the vertical level difference between the back surface 210b of the second cartridge 200 and the signal recording side 10A of the disk 10 that is stored in the second cartridge 200. Thus, the disk 10 can be mounted on the turntable 30b just as intended. In this manner, the second cartridge 200 can be accurately positioned with respect to, and loaded into, the disk drive 301 and the disk 10 can be appropriately mounted on the turntable 30b. Then, the optical pickup 40 can enter the second cartridge 200 through the window 210w and access the signal recording side 10A of the disk 10 to read or write a signal from/on the signal recording side 10A.

As described above, the disk drive of this preferred embodiment can be appropriately loaded with each of the two types of cartridges with mutually different planar shapes. Also, the disk drive of this preferred embodiment can rotate the disk, which is stored in the cartridge loaded, to read or write a signal from/on the disk.

Embodiment 2

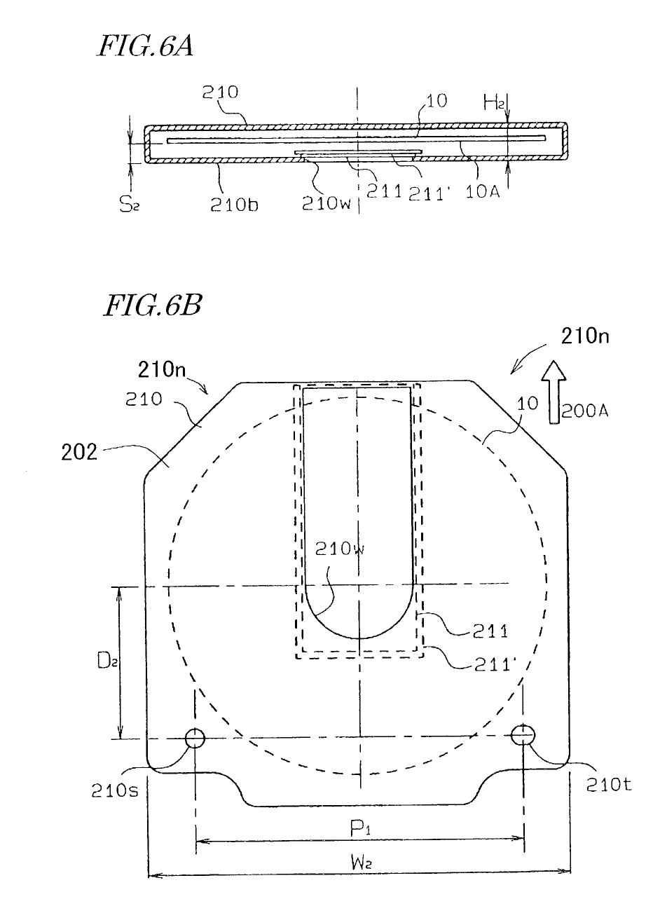

Hereinafter, a disk drive according to a second specific preferred embodiment of the present invention will be described. The disk drive of this preferred embodiment can be selectively loaded with either the first cartridge 100 of the first preferred embodiment described above or the second cartridge 202 shown in FIGS. 6A and 6B.

FIG. 6A is a cross-sectional view of the second cartridge 202 and FIG. 6B is a plan view thereof as viewed from over the back surface thereof. The second cartridge 202 shown in FIGS. 6A and 6B is a relatively stiff and highly dustproof version for business use. In FIGS. 6A and 6B, each member that is equivalent to the counterpart of the second cartridge 200 of the first preferred embodiment described above is identified by the same reference numeral.

As shown in FIGS. 6A and 6B, unlike the second cartridge 200 of the first preferred embodiment described above, the second cartridge 202 of this second preferred embodiment includes no reference plane 210p or 210q.

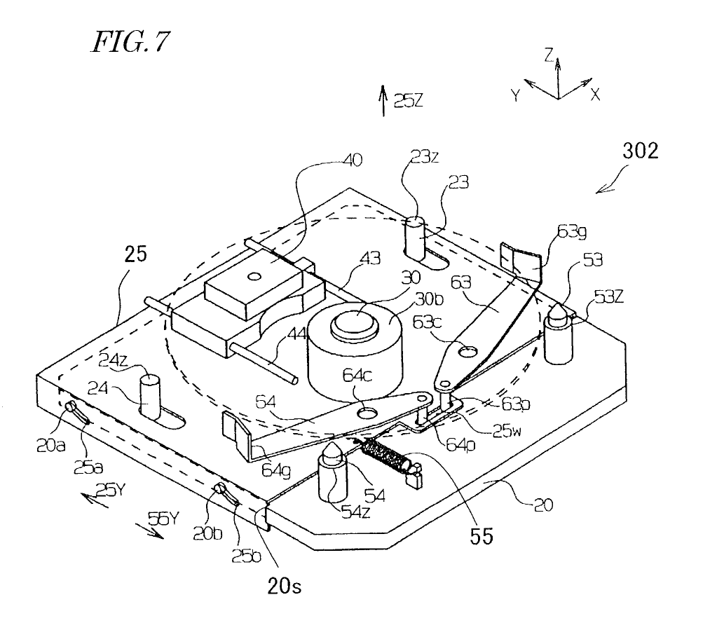

Next, a disk drive 302 according to the second preferred embodiment of the present invention will be described with reference to FIG. 7. In FIG. 7, each member that is equivalent to the counterpart of the disk drive 301 of the first preferred embodiment described above is identified by the same reference numeral. As shown in FIG. 7, the disk drive 302 includes the traverse chassis 20 and a sub-chassis 25. The sub-chassis 25 extends vertically to the cartridge inserting direction (i.e., Y direction) and both ends thereof are bent downward so as to be parallel to the side surfaces of the traverse chassis 20. These two downwardly bent ends of the sub-chassis 25 are provided with holes 25a, 25b, 25c and 25d. On the other hand, the two side surfaces of the traverse chassis 20 are provided with pins 20a, 20b, 20c and 20d that engage with the holes 25a, 25b, 25c and 25d of the sub-chassis 25, respectively. Thus, the sub-chassis 25 moves in the Y and Z directions with respect to the traverse chassis 20 so that the pins 20a, 20b, 20c and 20d of the traverse chassis 20 move along the holes 25a, 25b, 25c and 25d of the sub-chassis 25, respectively.

The spindle motor 30 and the optical pickup 40 are supported on the sub-chassis 25. Also, unlike the first preferred embodiment described above, the positioning pins 53 and 54 are secured to the traverse chassis 20.

As in the first preferred embodiment described above, the guide 63g is provided for one end of the actuator 63, while the guide 64g is provided for one end of the actuator 64. The other end of the actuator 63 includes the pin 63p and the other end of the actuator 64 includes the pin 64p. These pins 63p and 64p engage with an elongated hole 25w of the sub-chassis 25.

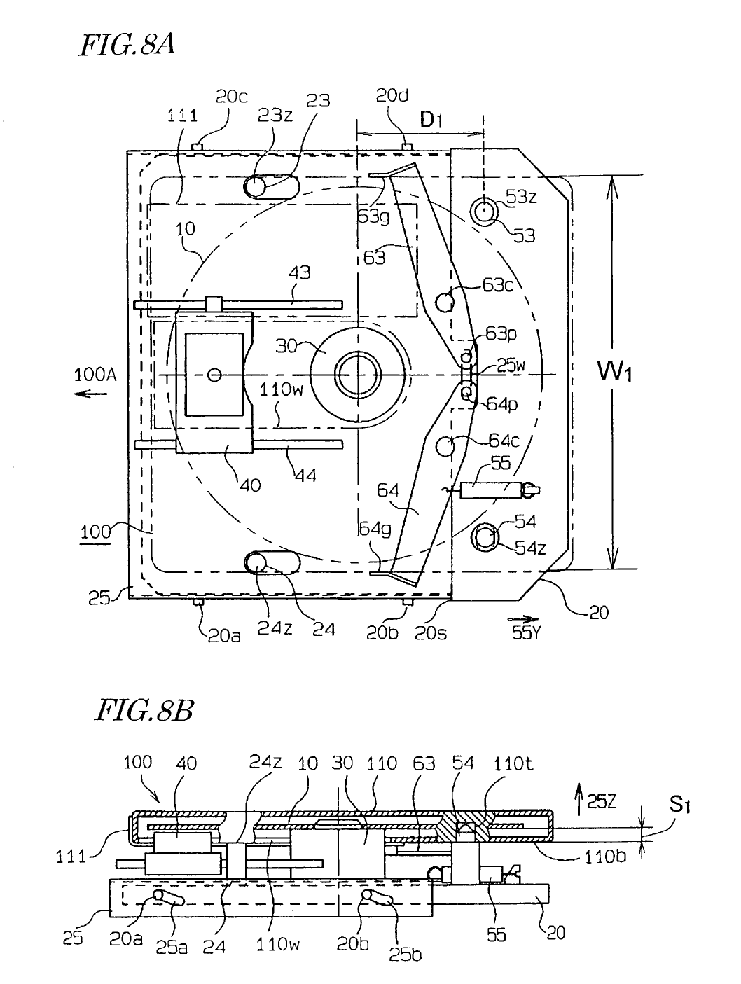

A spring 55 applies an elastic force to the sub-chassis 25 in the direction indicated by the arrow 55Y and is normally in contact with, and stopped by, the stopper 20s of the traverse chassis 20. In this state, the vertical level (i.e., the height as measured in the Z direction) of the bearing surfaces 53z and 54z of the positioning pins 53 and 54 and the bearing surfaces 23z and 24z of the regulating posts 23 and 24 is lower than that of the turntable 30b by S₁ as shown in FIG. 8B. Also, the distance between the center of rotation of the spindle motor 30 and the line that connects together the respective centers of the positioning pins 53 and 54 as measured in the Y direction is D₁ as shown in FIG. 8A. Furthermore, the distance between the two guides 63g and 64g is W₁, which is equal to the width of the first cartridge 100. Accordingly, as in the first preferred embodiment described above, while the first cartridge 100 is being inserted into this disk drive 302, the actuators 63 and 64 do not rotate, either.

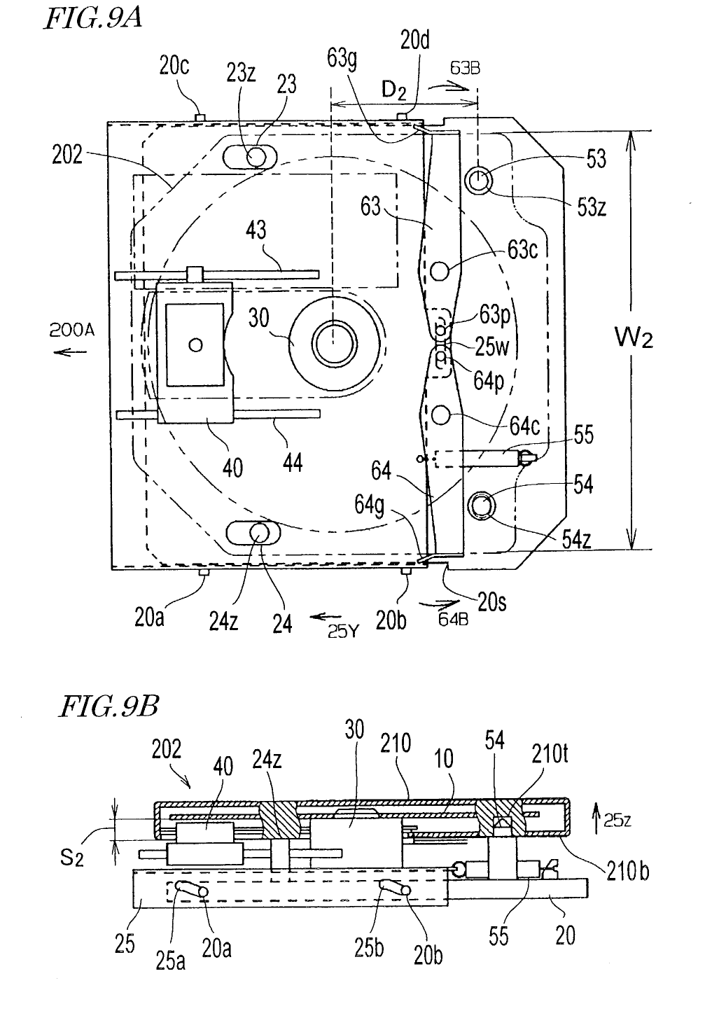

On the other hand, while the second cartridge 202 is being inserted into the disk drive 302, these guides 63g and 64g are pressed by the second cartridge 202 and the actuators 63 and 64 are rotated on a plane parallel to the signal recording side 10A of the disk 10 to such a degree that the distance between the guides 63g and 64g gets equal to the width W₂ of the second cartridge 202 as shown in FIG. 9A. As a result, the pins 63p and 64p moves the sub-chassis 25 in the Y and Z directions as shown in FIGS. 9A and 9B. As the sub-chassis 25 moves, the optical pickup 40 and the spindle motor 30 also move in the Y and Z directions with respect to the traverse chassis 20. Thus, the vertical level of the bearing surfaces 53z and 54z of the positioning pins 53 and 54 and the bearing surfaces 23z and 24z of the regulating posts 23 and 24 gets lower than that of the turntable 30b by S₂ as shown in FIG. 9B. Also, the distance between the center of rotation of the spindle motor 30 and the line that connects together the respective centers of the positioning pins 53 and 54 as measured in the Y direction becomes D₂ as shown in FIG. 9A.

Hereinafter, it will be described how the disk drive 302 is loaded with the first or second cartridge 100 or 202.

FIGS. 8A and 8B are respectively a plan view and a cross-sectional view illustrating a state where the first cartridge 100 has been loaded into the disk drive 302.

As in the first preferred embodiment described above, in a normal state, an elastic force is applied from the spring 55 to the sub-chassis 55 in the direction 55Y and the sub-chassis 25 is in contact with the stopper 20s of the traverse chassis 20. In this state, the distance between the guides 63g and 64g is approximately equal to W₁.

Suppose the first cartridge 100 is inserted into the disk drive 302 in the direction 100A. In that case, since the width of the first cartridge 100 is W₁, the guides 63g and 64g of the actuators 63 and 64 allow the first cartridge 100 being inserted to go deeper into the disk drive 302 without moving from their home positions.

During this loading operation, the actuators 63 and 64 do not move at all, neither does the sub-chassis 25. Accordingly, the distance between the line that connects together the respective centers of the positioning pins 53 and 54 and the center of the spindle motor 30 is equal to D₁, and the distance (or the difference in vertical level) between the bearing surfaces 53z and 54z of the positioning pins 53 and 54 and the turntable 30b (which is as high as the signal recording side 10A of the disk 10) is S₁.

While the first cartridge 100 is being inserted in the direction 100A, the shutter opening/closing mechanism (not shown) of the disk drive 302 opens the shutter 111 of the first cartridge 100. And when the first cartridge 100 being inserted reaches a position where the positioning holes 110s and 110t thereof are located over the positioning pins 53 and 54, the positioning pins 53 and 54 engage with the positioning holes 110s and 110t, respectively. In this manner, the position of the first cartridge 100 on the X-Y plane is defined. As described above, the distance between the line that connects together the respective centers of the positioning pins 53 and 54 and the center of the spindle motor 30 is D₁, which is equal to the distance between the line that connects together the respective centers of the positioning holes 110s and 110t of the first cartridge 100 and the center of the disk 10 stored in the first cartridge 100. Thus, the center of the disk 10 that is stored in the first cartridge 100 can be aligned with the center of the spindle motor 30.

Also, at this point in time, the bearing surfaces 23z and 24z of the regulating posts 23 and 24 contact with the back surface 110b of the first cartridge 100 and the bearing surfaces 53z and 54z of the positioning pins 53 and 54 also contact with the back surface 110b. As a result, the position of the first cartridge 100 in the thickness direction (i.e., vertical level thereof) is defined. As described above, the vertical level difference between the bearing surfaces 23z and 24z of the regulating posts 23 and 24 or the bearing surfaces 53z and 54z of the positioning pins 53 and 54 and the turntable 30b is S₁, which is equal to the vertical level difference between the back surface 110b of the first cartridge 100 and the signal recording side 10A of the disk 10 that is stored in the first cartridge 100. Thus, the disk 10 can be mounted on the turntable 30b just as intended. In this manner, the first cartridge 100 can be accurately positioned with respect to, and loaded into, the disk drive 302 and the disk 10 can be appropriately mounted on the turntable 30b. Then, the optical pickup 40 can enter the first cartridge 100 through the window 110w and access the signal recording side 10A of the disk 10 to read or write a signal from/on the signal recording side 10A.

FIGS. 9A and 9B are respectively a plan view and a cross-sectional view illustrating a state where the second cartridge 202 has been loaded into the disk drive 302.

While the disk drive 302 is in its initial state, the distance between the guides 63g and 64g is W₁, which is equal to the width of the first cartridge 100. On the other hand, the second cartridge 202 includes the notches 210n at the two corners thereof near its window 210w. Accordingly, the width of the cartridge body 210 thereof changes from W₃ into W₂ at the end thereof. Since W₃<W₁<W₂, the notched end portion of the second cartridge 202 is inserted into the disk drive 302 without contacting with the guide 63g or 64g.

However, as the second cartridge 202 is inserted deeper into the disk drive 302, the guides 63g and 64g soon contact with, and are pressed by, the non-notched side surfaces of the second cartridge 202. As a result, on a plane parallel to the signal recording side 10A of the disk 10, the actuators 63 and 64 rotate on the shafts 63c and 64c toward the directions indicated by the arrows 63B and 64B, respectively. These directions 63B and 64B are opposite to those 63A and 64A of the first preferred embodiment described above. Meanwhile, the pins 63p and 64p of the actuators 63 and 64 press the sub-chassis 25 in the direction indicated by the arrow 25Y.

As a force is applied from the pins 63p and 64p to the sub-chassis 25 in the direction 25Y, the sub-chassis 25 moves with respect to the traverse chassis 20 so that the pins 20a, 20b, 20c and 20d of the traverse chassis 20 move along the holes 25a, 25b, 25c and 25d of the sub-chassis 25, respectively. As shown in FIG. 9B, the holes 25a, 25b, 25c and 25d extend diagonally with respect to the directions 25Y and 25Z so as to have components in the directions 25Y and 25Z. Accordingly, the sub-chassis 25 moves in the directions 25Y and 25Z with respect to the traverse chassis 20 and the distance between the line that connects together the respective centers of the positioning pins 53 and 54 and the center of the spindle motor 30 becomes D₂, which is equal to the distance between the line that connects together the respective centers of the positioning holes 210s and 210t of the second cartridge 202 and the center of the disk 10 that is stored in the second cartridge 202. Also, the vertical level difference between the bearing surfaces 53z and 54z of the positioning pins 53 and 54 or the bearing surfaces 23z and 24z of the regulating posts 23 and 24 and the turntable 30b (which is as high as the signal recording side 10A of the disk 10) becomes S₂, which is equal to the vertical level difference between the back surface 210b of the second cartridge 202 and the signal recording side 10A of the disk 10 that is stored in the second cartridge 202.

When the second cartridge 202 being inserted reaches a position where the positioning holes 210s and 210t thereof are located over the positioning pins 53 and 54, the positioning pins 53 and 54 engage with the positioning holes 210s and 210t, respectively. In this manner, the position of the second cartridge 202 on the X-Y plane is defined. As described above, the distance between the line that connects together the respective centers of the positioning pins 53 and 54 and the center of the spindle motor 30 is D₂, which is equal to the distance between the line that connects together the respective centers of the positioning holes 210s and 210t of the second cartridge 202 and the center of the disk 10 stored in the second cartridge 202. Thus, the center of the disk 10 that is stored in the second cartridge 202 can be aligned with the center of the spindle motor 30.

Also, at this point in time, the bearing surfaces 23z and 24z of the regulating posts 23 and 24 and the bearing surfaces 53z and 54z of the positioning pins 53 and 54 contact with the back surface 210b of the second cartridge 202. As a result, the position of the second cartridge 202 in the thickness direction (i.e., vertical level thereof) is defined. As described above, the vertical level difference between the bearing surfaces 53z and 54z or 23z and 24z and the turntable 30b is S₂, which is equal to the vertical level difference between the back surface 210b of the second cartridge 202 and the signal recording side 10A of the disk 10 that is stored in the second cartridge 202. Thus, the disk 10 can be mounted on the turntable 30b just as intended. In this manner, the second cartridge 202 can be accurately positioned with respect to, and loaded into, the disk drive 302 and the disk 10 can be appropriately mounted on the turntable 30b. Then, the optical pickup 40 can enter the second cartridge 202 through the window 210w and access the signal recording side 10A of the disk 10 to read or write a signal from/on the signal recording side 10A.

As described above, the disk drive of this preferred embodiment can be appropriately loaded with each of the two types of cartridges with mutually different planar shapes. Also, the disk drive of this preferred embodiment can rotate the disk, which is stored in the cartridge loaded, to read or write a signal from/on the disk.

Embodiment 3

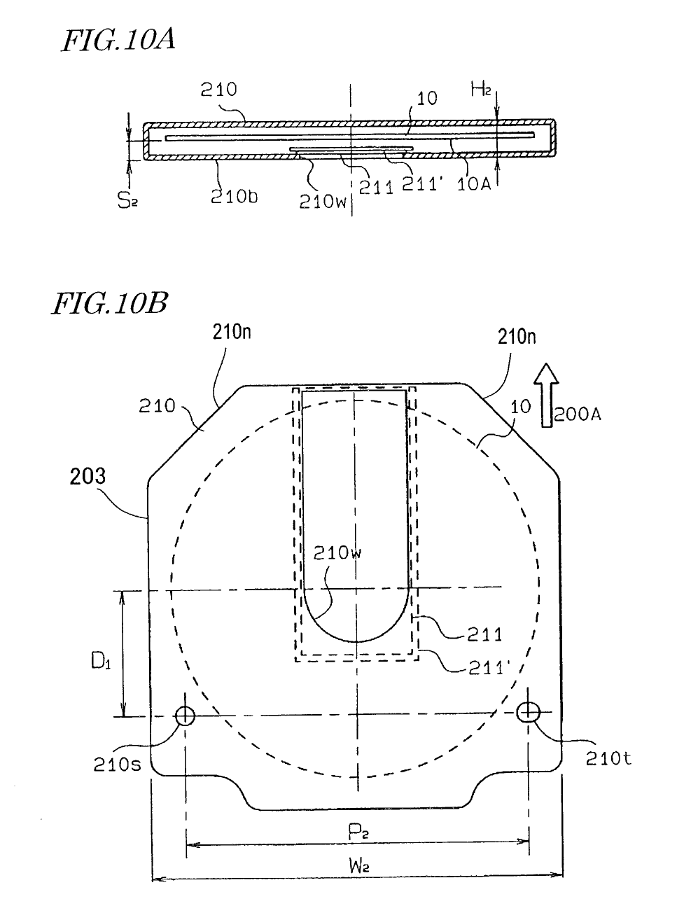

Hereinafter, a disk drive according to a third specific preferred embodiment of the present invention will be described. The disk drive of this preferred embodiment can be selectively loaded with either the first cartridge 100 of the first preferred embodiment shown in FIGS. 1A and 1B or the second cartridge 203 shown in FIGS. 10A and 10B.

FIG. 10A is a cross-sectional view of the second cartridge 203 and FIG. 10B is a plan view thereof as viewed from over the back surface thereof. The second cartridge 203 shown in FIGS. 10A and 10B is a relatively stiff and highly dustproof version for business use. In FIGS. 10A and 10B, each member that is equivalent to the counterpart of the second cartridge 202 of the second preferred embodiment shown in FIGS. 6A and 6B is identified by the same reference numeral.

As shown in FIGS. 10A and 10B, the second cartridge 203 of this third preferred embodiment is different from the second cartridge 202 of the second preferred embodiment described above in that the distance between the respective centers of the positioning holes 210s and 210t is P₂ and that the distance between the center of the disk 10 stored in the second cartridge 203 and the line that connects together the respective centers of the positioning holes 210s and 210t is D₁. The distance P₂ is greater than the distance P₁ between the respective centers of the positioning holes 210s and 210t of the second cartridge 202 according to the second preferred embodiment described above. That is to say, in this second cartridge 203, although the distance between the center of the disk and the line that connects together the respective centers of the positioning holes 210s and 210t is equal to that of the first cartridge 100, the distance between the respective centers of the positioning holes 210s and 210t is greater than that of the first cartridge 100.

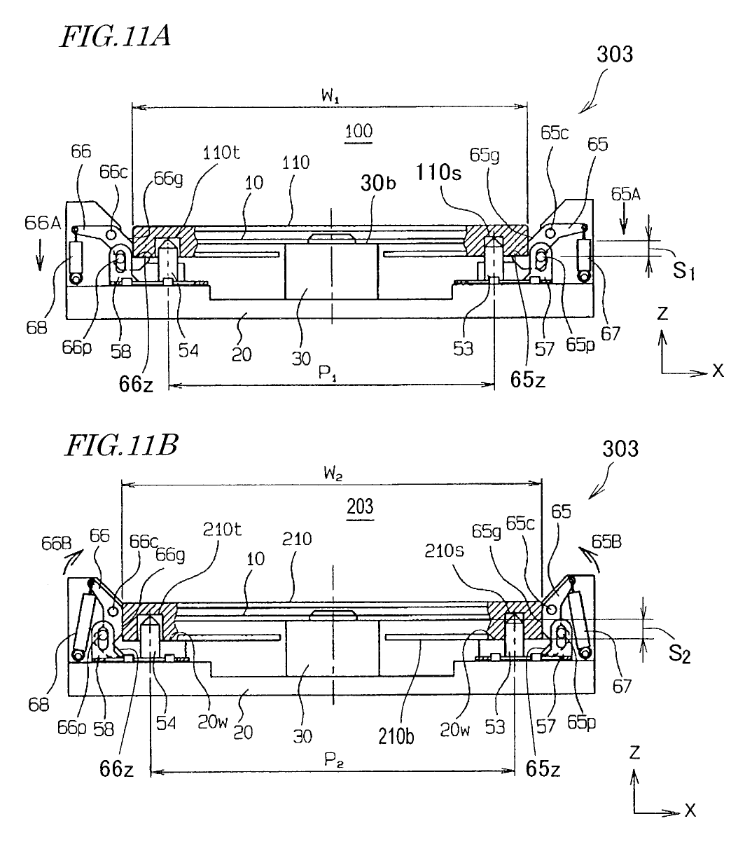

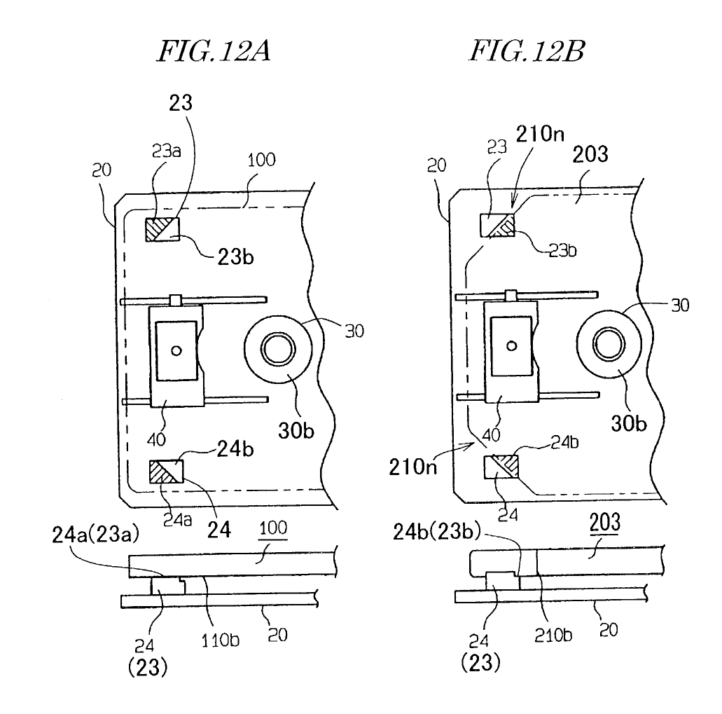

Hereinafter, a disk drive 303 according to the third preferred embodiment of the present invention will be described with reference to FIGS. 11A, 11B, 12A and 12B. FIGS. 11A and 11B are cross-sectional views of the disk drive 303 as viewed in the cartridge inserting direction, while FIGS. 12A and 12B are plan views thereof illustrating a portion of the disk drive 303 near the optical pickup 40. FIGS. 11A and 12A illustrate a state of the disk drive 303 in which the first cartridge 100 has been loaded, while FIGS. 11B and 12B illustrate a state of the disk drive 303 in which the second cartridge 203 has been loaded.

As shown in FIG. 11A, the disk drive 303 includes actuators 65 and 66, which rotate on shafts 65c and 66c on a plane that crosses the traverse chassis 20 at right angles. A spring 67 applies an elastic force to one end of the actuator 65 in the direction indicated by the arrow 65A, while a spring 68 applies an elastic force to one end of the actuator 66 in the direction indicated by the arrow 66A. The positioning pins 53 and 54 of this third preferred embodiment have no bearing surfaces but are secured to positioning bases 57 and 58, respectively. The positioning bases 57 and 58 are supported on the traverse chassis 20 so as to be movable in the X direction and engage with the actuators 65 and 66 via pins 65p and 66p, respectively.

The actuator 65 includes a guide surface 65g and a bearing surface 65z, while the actuator 66 includes a guide surface 66g and a bearing surface 66z. In the initial state, the distance between the guide surfaces 65g and 66g is W₁. At this point in time, the bearing surfaces 65z and 66z are parallel the turntable 30b and lower than the turntable 30b by S₁. Also, the distance between the respective centers of the positioning pins 53 and 54 is P₁.

As shown in FIGS. 12A and 12B, the disk drive 303 includes regulating posts 23 and 24. The bearing surfaces 23a and 24a at the top of the regulating posts 23 and 24 include concave portions 23b and 24b that engage with the notched side surfaces 210n of the second cartridge 203. The bearing surfaces 23a and 24a are lower than the turntable 30b by S₁, while the concave portions 23b and 24b are lower than the turntable 30b by S₂.

While the first cartridge 100 is being inserted into the disk drive 303, the first cartridge 100 is supported on the bearing surfaces 65z and 66z of the actuators 65 and 66 without rotating the actuator 65 or 66. This is because the distance between the guide surfaces 65g and 66g is W₁. In this manner, the position of the first cartridge 100 in the thickness direction (i.e., in the Z direction) is defined. Also, the positioning pins 53 and 54 are inserted into the positioning holes 110s and 110t, thereby defining the position of the first cartridge 100 in the direction parallel to the signal recording side 10A of the disk 10 that is stored in the first cartridge 100.

In this case, the back surface 110b of the first cartridge 100 contacts with the bearing surfaces 23a and 24a and are supported on the regulating posts 23 and 24 as shown in FIG. 12A. Thus, the disk 10 that is stored inside the first cartridge 100 can be mounted on the turntable 30b just as intended.

On the other hand, while the second cartridge 203 is being inserted into the disk drive 303, the guide surfaces 65g and 66g of the actuators 65 and 66 are pressed by the second cartridge 203, thereby rotating the actuators 65 and 66 to the directions indicated by the arrows 65B and 66B as shown in FIG. 11B. Thus, the positioning bases 57 and 58 are moved outward to increase the gap between the respective centers of the positioning pins 53 and 54. When the distance between the guide surfaces 65g and 66g reaches W₂, the distance between the respective centers of the positioning pins 53 and 54 becomes P₂. Meanwhile, the bearing surfaces 65z and 66z are retracted so as not to contact with the second cartridge 203. Then, the reference plane 20w of the traverse chassis 20 comes into contact with the back surface 210b of the second cartridge 203. The reference plane 20w is lower than the turntable 30b by S₂. Thus, the positioning pins 53 and 54 are inserted into the positioning holes 210s and 210t and the position of the second cartridge 203 in the horizontal direction is defined. Also, the second cartridge 203 is supported so that the back surface 210b thereof contacts with the reference plane 20w.

As shown in FIG. 12B, the back surface 210b of the second cartridge 203 is supported by the regulating posts 23 and 24 in such a manner as to contact with the concave portions 23b and 24b of the regulating posts 23 and 24. Thus, the disk 10 that is stored in the second cartridge 203 can be mounted on the turntable 30b just as intended.

As described above, the disk drive of this preferred embodiment can be appropriately loaded with each of the two types of cartridges with mutually different planar shapes. Also, the disk drive of this preferred embodiment can rotate the disk, which is stored in the cartridge loaded, to read or write a signal from/on the disk.

Embodiment 4

Hereinafter, a disk drive according to a fourth specific preferred embodiment of the present invention will be described. The disk drive of this preferred embodiment can be selectively loaded with either the first cartridge 100 of the first preferred embodiment shown in FIGS. 1A and 1B or the second cartridge 203 of the third preferred embodiment shown in FIGS. 10A and 10B.

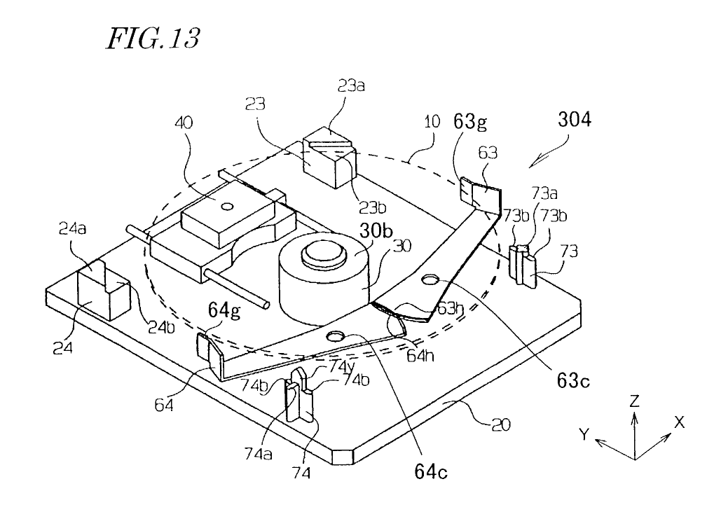

FIG. 13 illustrates a disk drive 304 according to the fourth preferred embodiment of the present invention. In FIG. 13, each member of the disk drive 304 that is equivalent to the counterpart of the disk drive 301, 302 or 303 according to the first, second or third preferred embodiment of the present invention described above is identified by the same reference numeral. The regulating posts 23 and 24 of the disk drive 304 of the fourth preferred embodiment have the same structure as the counterparts of the disk drive 303 of the third preferred embodiment described above.

The actuators 63 and 64 rotate on shafts 63c and 64c on a plane that is parallel to the traverse chassis 20. One end of the actuator 63 includes a gear 63h, while one end of the actuator 64 includes a gear 64h that engages with the gear 63h of the actuator 63.

The disk drive 604 includes positioning ribs 73 and 74 instead of the positioning pins. The positioning rib 74 includes a Y-regulating rib 74y and bearing surfaces 74a and 74b. The Y-regulating rib 74y is located in a region that will be under each of the positioning holes 110t and 210t of the first and second cartridges 100 and 203, i.e., provided so as to be inserted into each of the positioning holes 110t and 210t, thereby regulating the position of the first or second cartridge 100 or 203 only in the Y direction. The bearing surface 74a is fully inserted into the positioning hole 210t of the second cartridge 203 but receives the back surface 110b of the first cartridge 100, while the bearing surface 74b receives the back surface 210b of the second cartridge 203.

On the other hand, the positioning rib 73 includes: a bearing surface 73a that is fully inserted into the positioning hole 210s of the second cartridge 203 but that receives the back surface 110b of the first cartridge 100; and a bearing surface 73b that receives the back surface 210b of the second cartridge 203. In this case, the bearing surfaces 73a and 74a are lower than the turntable 30b by S₁, while the bearing surfaces 73b and 74b are lower than the turntable 30b by S₂.

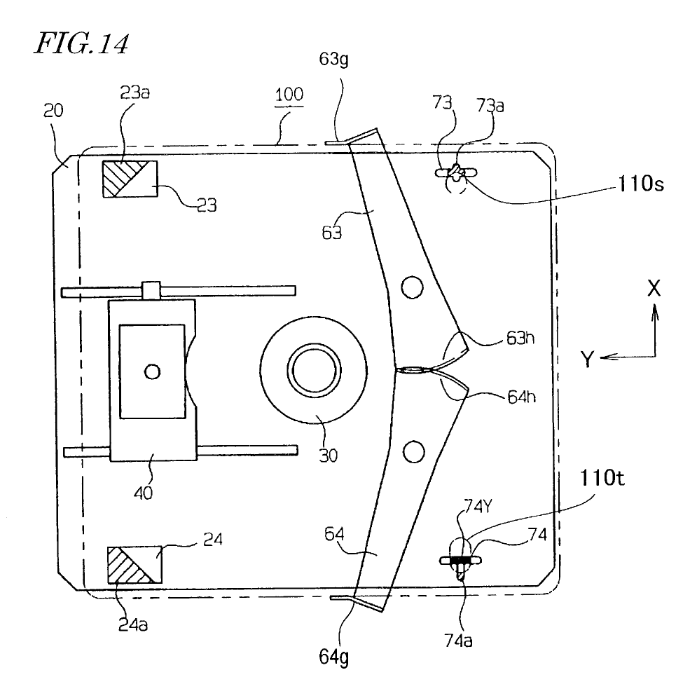

FIG. 14 illustrates a state of the disk drive 304 in which the first cartridge 100 has been loaded. In the disk drive 304, the actuators 63 and 64 are interlocked with each other and the distance between the guide surface 63g and the center of the turntable 30b is always equal to the distance between the guide surface 64g and the center of the turntable 30b. Accordingly, if the first cartridge 100 is inserted into this disk drive 304 so as to contact with the guide surfaces 63g and 64g, the center of the first cartridge 100 is aligned with that of the disk drive 304 in the X direction.

The first cartridge 100 may be positioned in the Y and Z directions in the following manner. When the first cartridge 100 is loaded into the disk drive 304, the Y-regulating rib 74y is inserted into the outside portion of the positioning hole 110t of the first cartridge 100 as shown in FIG. 14, thereby regulating the position of the first cartridge 100 in the Y direction. Also, the bearing surfaces 73a and 74a of the positioning ribs 73 and 74 and the bearing surfaces 23a and 24a of the regulating posts 23 and 24 contact with the back surface 110b of the first cartridge 100, thereby defining the position of the first cartridge 100 in the Z direction. Thus, the disk 10 that is stored inside the first cartridge 100 can be mounted on the turntable 30b just as intended.

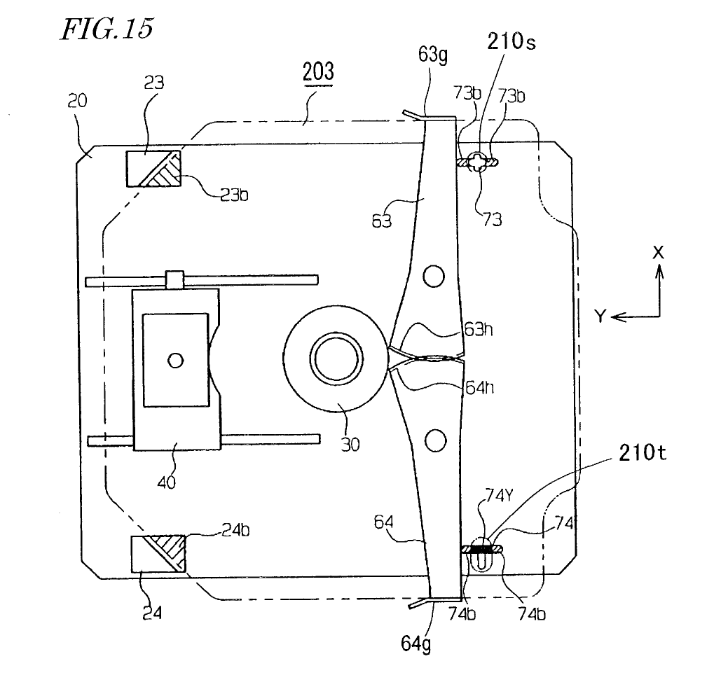

FIG. 15 illustrates a state of the disk drive 304 in which the second cartridge 203 has been loaded. While the second cartridge 203 is inserted into the disk drive 304, the second cartridge 203 contacts with the guide surfaces 63g and 64g of the actuators 63 and 64, thereby rotating the actuators 63 and 64 until the gap between the guide surfaces 63g and 64g becomes W₂. As described above, the center of the second cartridge 203 is aligned by the guide surfaces 63g and 64g with that of the disk drive 304 in the X direction.

On the other hand, as shown in FIG. 15, the Y-regulating rib 74y is inserted into the inside portion of the positioning hole 210t, thereby regulating the position of the second cartridge 203 in the Y direction. Also, the bearing surfaces 73b and 74b of the positioning ribs 73 and 74 and the concave portions 23b and 24b of the regulating posts 23 and 24 contact with the back surface 210b of the second cartridge 203, thereby defining the position of the second cartridge 203 in the Z direction. Thus, the disk 10 that is stored inside the second cartridge 203 can be mounted on the turntable 30b just as intended.

As described above, the disk drive of this preferred embodiment can be appropriately loaded with each of the two types of cartridges with mutually different planar shapes. Also, the disk drive of this preferred embodiment can rotate the disk, which is stored in the cartridge loaded, to read or write a signal from/on the disk.

Embodiment 5

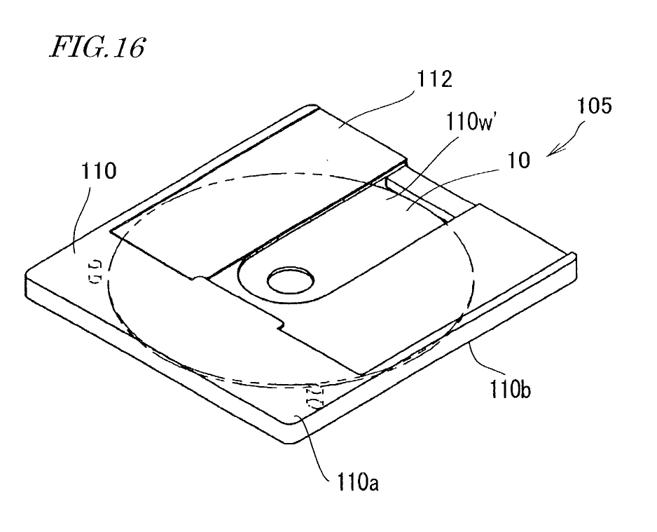

Hereinafter, a disk drive according to a fifth specific preferred embodiment of the present invention will be described. First, multiple types of cartridges that can be selectively loaded into the disk drive of the fifth preferred embodiment will be described with reference to FIGS. 16 through 21B. The disk drive of this fifth preferred embodiment can be loaded with any of multiple cartridges in which storage media complying with mutually different standards are stored.

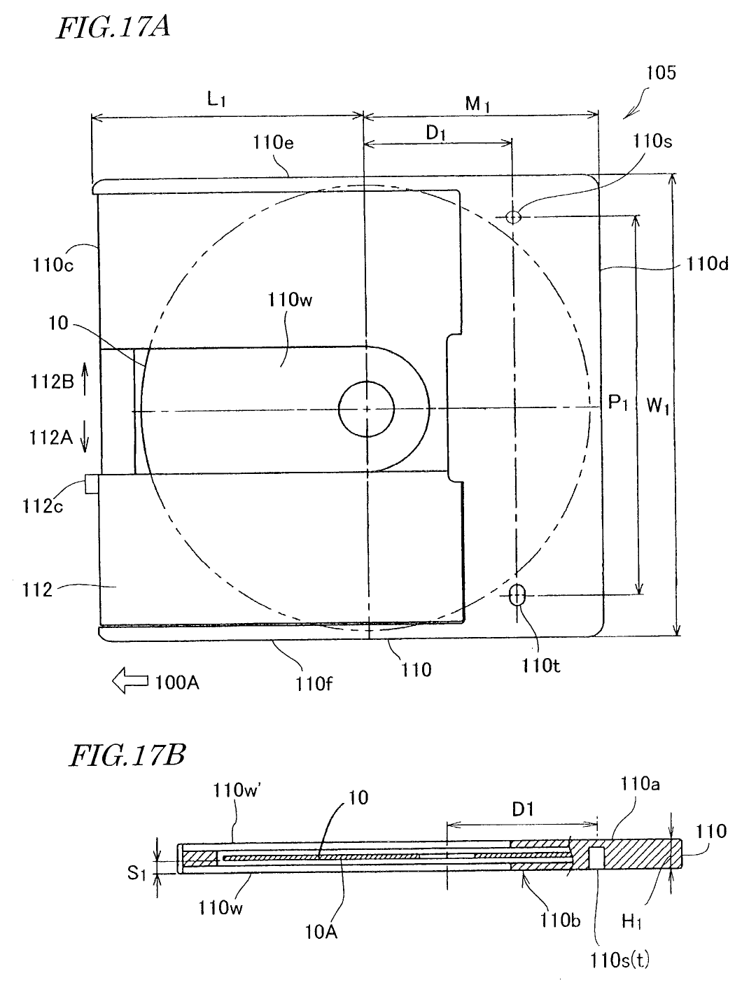

FIG. 16 is a perspective view illustrating a first cartridge 105. FIGS. 17A and 17B are respectively a plan view of the first cartridge 105 as viewed from over the back surface thereof and a cross-sectional view thereof illustrating a plane that is parallel the direction 100A in FIG. 17A. The first cartridge 105 may be a cartridge in which a DVD-RAM disk is stored, for example.

As shown in FIGS. 16, 17A and 17B, the first cartridge 105 includes a cartridge body 110 for storing a disk 10 therein. The cartridge body 110 includes a window 110w on the back surface 110b thereof to allow a member for rotating the disk 10 (e.g., a spindle motor) and a read/write head to enter the cartridge body 110 and access the disk 10. Another window 110w′ that has the same shape as the window 110w is further provided on the upper surface 110a of the cartridge body 110.

Also, a shutter 112 that is bent so as to cover both the upper surface 110a and the back surface 110b alike is externally provided on the cartridge body 110 to open or close the windows 110w and 110w′ simultaneously. That is to say, when the shutter 112 is open, the signal recording side 10A of the disk 10 is partially exposed inside the windows 110w.

The first cartridge 105 has a thickness H₁. While the disk 10 is held inside the cartridge body 110 so as to be rotatable therein, the distance between the back surface 110b of the cartridge body 110 and the signal recording side 10A of the disk 10 is S₁. Also, the first cartridge 105 is inserted into a disk drive (not shown) in the direction 100A. The width of the first cartridge 105 as measured vertically to the inserting direction 100A is W₁.

The back surface 110b of the cartridge body 110 includes positioning holes 110s and 110t that are provided to define the position of the cartridge 105 on a plane, which is parallel the signal recording side 10A of the disk 10, inside the disk drive. Of these two positioning holes 110s and 110t, the positioning hole 110t defines the position of the cartridge 105 in the direction vertical to the direction 100A. The distance between the centers of the two positioning holes 110s and 110t is P₁. Also, in reading or writing a signal from/on the disk 10, the distance between the center of the disk 10 and the line that connects together the respective centers of the positioning holes 110s and 110t is D₁. It should be noted that the locations of the positioning holes 110s and 110t of the fifth preferred embodiment are opposite to those of the positioning holes 110s and 110t of the first through fourth preferred embodiments described above.

Furthermore, the distance between the center of the disk 10 and a side surface 110c of the cartridge body 110 that is adjacent to the windows 110w and 110w′ is L₁, while the distance between the center of the disk 10 and the side surface 110d that is opposed to the side surface 110c is M₁.

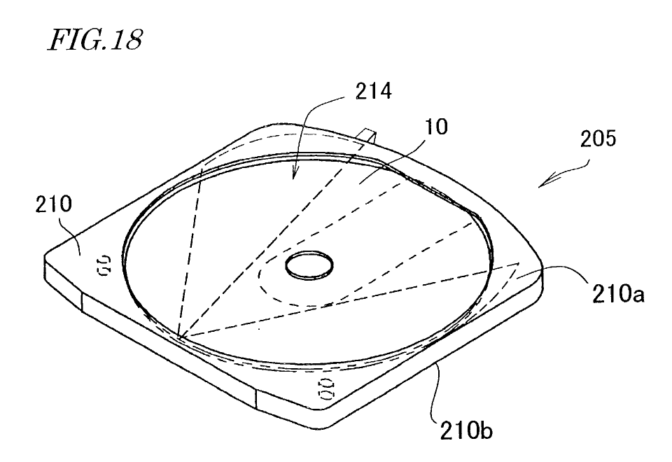

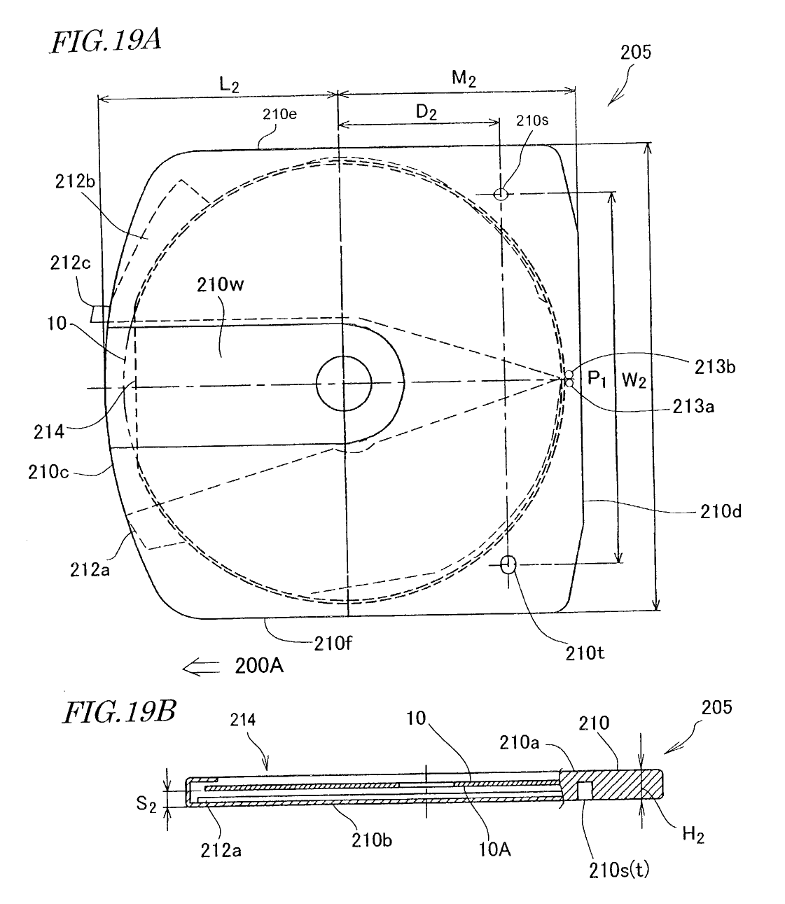

FIG. 18 is a perspective view of a second cartridge 205. FIGS. 19A and 19B are respectively a plan view of the second cartridge 205 as viewed from over the back surface thereof and a cross-sectional view thereof illustrating a plane that is parallel the direction 200A in FIG. 19A. The second cartridge 205 is disclosed in WO 02/056313A1, for example.

As shown in FIGS. 18, 19A and 19B, the second cartridge 205 includes a cartridge body 210 for storing a disk 10 therein. The cartridge body 210 includes a window 210w on the back surface 210b thereof to allow a member for rotating the disk 10 (e.g., a spindle motor) and a read/write head to enter the cartridge body 210 and access the disk 10. Another window 214 that exposes the disk 10 almost entirely is further provided on the upper surface 210a of the cartridge body 210.

Shutters 212a and 212b are provided inside the cartridge body 210 to open or close the window 210w. The shutters 212a and 212b rotate on shafts 213a and 213b, respectively. An opener/closer 212c is provided for the shutter 212b. An interlocking mechanism is provided near the shafts 213a and 213b to interlock the shutters 212a and 212b together and operate them synchronously with each other. Accordingly, by operating the opener/closer 212c externally, the shutters 212a and 212b can be both rotated and opened or closed. When these shutters 212a and 212b are open, the signal recording side 10A of the disk 10 is partially exposed inside the window 210w.

The second cartridge 205 has a thickness H₂. While the disk 10 is held inside the cartridge body 210 so as to be rotatable therein, the distance between the back surface 210b of the cartridge body 210 and the signal recording side 10A of the disk 10 is S₂ Also, the second cartridge 205 is inserted into a disk drive (not shown) in the direction 200A. The width of the second cartridge 205 as measured vertically to the inserting direction 200A is W₂. In this preferred embodiment, H₂, S₂ and W₂ of the second cartridge 205 are greater than H₁, S₁ and W₁ of the first cartridge 105, respectively.

The back surface 210b of the cartridge body 210 includes positioning holes 210s and 210t that are provided to define the position of the cartridge 205 on a plane, which is parallel to the signal recording side 10A of the disk 10, inside the disk drive. Of these two positioning holes 210s and 210t, the positioning hole 210t defines the position of the cartridge 205 in the direction vertical to the direction 200A. As in the first cartridge 105, the distance between the centers of the two positioning holes 210s and 210t is P₁. Also, in reading or writing a signal from/on the disk 10, the distance between the center of the disk 10 and the line that connects together the centers of the positioning holes 210s and 210t is D₂, which is greater than the distance D₁ of the first cartridge 105.

Furthermore, the distance between the center of the disk 10 and a side surface 210c of the cartridge body 210 that is adjacent to the windows 210w is L₂, while the distance between the center of the disk 10 and the side surface 210d that is opposed to the side surface 210c is M₂.

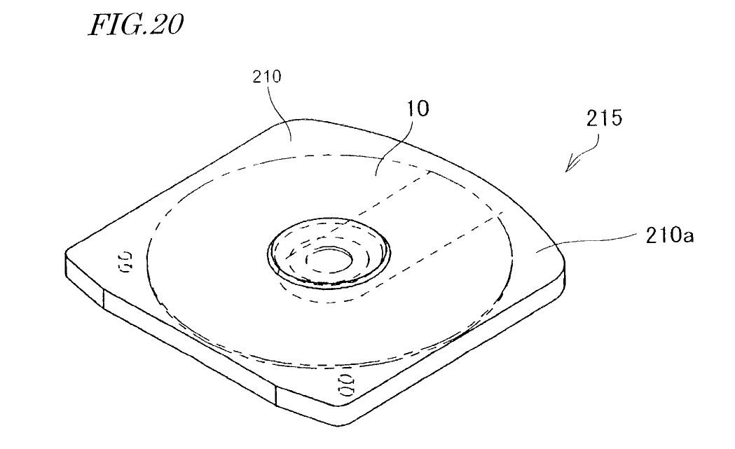

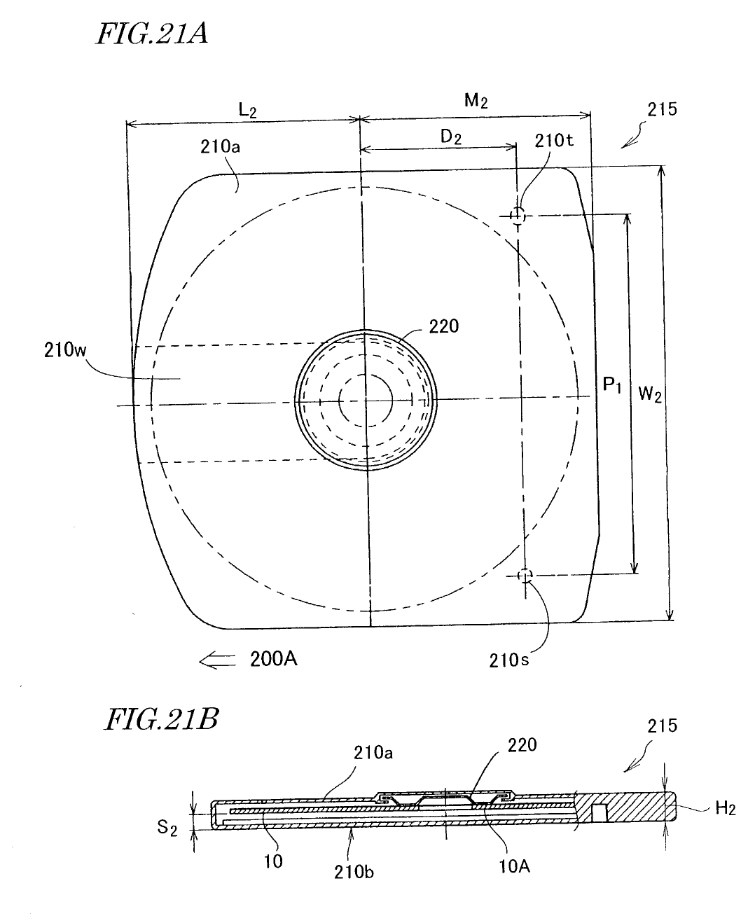

FIG. 20 is a perspective view of a third cartridge 215. FIGS. 21A and 21B are respectively a plan view of the third cartridge 215 as viewed from over the upper surface thereof and a cross-sectional view thereof illustrating a plane that is parallel the direction 200A in FIG. 21A.

Unlike the second cartridge 205 described above, the upper surface 210a of the third cartridge 215 includes no window to expose one side of the disk inside. Also, the third cartridge 215 includes a clamper 220 between the disk 10 and the upper surface 210a of the cartridge body 210.

The planar shape of the third cartridge 215 is the same as that of the second cartridge 205. The positioning holes 210s and 210t of the third cartridge 215 are also located at the same positions as those of the second cartridge 205.

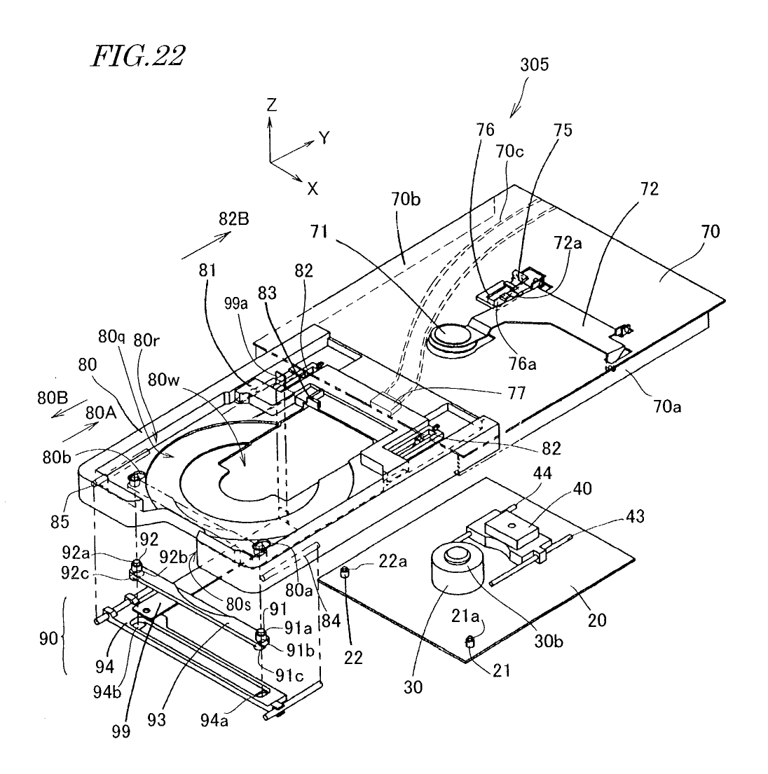

Next, a disk drive 305 that can be loaded with any of the first, second and third cartridges 105, 205 and 215 will be described. In the following description of the disk drive 305 according to this fifth preferred embodiment, if some statement applies to any of the first, second and third cartridges 105, 205 and 215, the object will be herein simply referred to as a “cartridge”. As shown in FIG. 22, the disk drive 305 includes a traverse chassis 20, a spindle motor 30 as a driving means and an optical pickup 40 as a read/write head.

The spindle motor 30 includes a turntable 30b (i.e., a disk mount plane) for mounting the disk 10 thereon, and is secured to the traverse chassis 20. The optical pickup 40 is supported on the traverse chassis 20 so as to be movable on guide shafts 43 and 44. A pair of fixing pins 21 and 22 is provided on the traverse chassis 20. The fixing pins 21 and 22 include bearing surfaces 21a and 22a near their tops.

The disk drive 305 further includes a roof 70, a tray 80 and a positioning structure 90. The roof 70 is provided with a clamper 71, a clamper supporter 72, a sensor lever 75, a sensor lever supporter 76 and a shutter opener/closer 77. The roof 70 further includes guide grooves 70a and 70b for use to store the tray 80 inside the disk drive 305 and another guide groove 70c to slide the shutter opener/closer 77 thereon. One end of the guide groove 70c is located near the center on the front side of the roof 70, while the other end of the guide groove 70c is located close to the guide groove 70b on the rear side of the roof 70. The sensor lever 75 is supported by the sensor lever supporter 76, to which an elastic force is applied from an elastic member (e.g., spring) not shown in the direction indicated by the arrow 80B. The sensor lever supporter 76 can be moved in the opposite direction indicated by the arrow 80A against the elastic force applied thereto. The sensor lever supporter 76 includes a stopper 76a as a protrusion. When the sensor lever supporter 76 is moved in the direction 80A, the stopper 76a is located under a convex portion 72a that is provided for the clamper supporter 72. Then, the stopper 76a contacts with the convex portion 72a, thereby preventing the clamper supporter 72 from lowering.

The tray 80 includes a concave portion 80r to store the cartridge therein. The bottom of the concave portion 80r includes a window 80w to allow the spindle motor 30 and the optical pickup 40 to access the disk 10 that is stored in the cartridge loaded. The tray 80 further includes a slider 81 and springs 82 as elastic members. The springs 82 apply an elastic force to the slider 81 in the direction indicated by the arrow 82B. A protrusion 83 is further provided beside the window 80w so as to engage with the sensor lever 75 on the roof 70.

In the disk drive 305, the bottom of the concave portion 80r may further include a circular concave portion 80q as shown in FIG. 22 to directly mount a disk that is not stored in the cartridge. Also, to get the cartridge removed from the concave portion 80r of the tray 80 more easily, the front side of the tray 80 may include a notch 80s that partially exposes the front side of the cartridge.

The positioning structure 90 includes a positioner 93 with a pair of positioning pins 91 and 92 and a supporter 94 that has a space to store the positioner 93 therein. The positioning pins 91 and 92 include the tops to be inserted into the positioning holes of the cartridge and bearing surfaces 91a and 92a. The positioning pins 91 and 92 further include positioning holes 91b, 91c and 92b, 92c, respectively, at the bottom thereof. These positioning holes 91b, 91c and 92b, 92c are exposed inside the holes 94a and 94b of the supporter 94, respectively.

The positioner 93 is movable in the Z direction inside the space of the supporter 94. The positioning structure 90 is supported on the back surface of the tray 80 in such a manner as to be movable on guide shafts 84 and 85 of the tray 80 in the direction 80A or 80B. An elastic member (not shown) applies an elastic force to the positioning structure 90 in the direction 80B. The positioning pins 91 and 92 protrude through holes 80a and 80b on the bottom of the concave portion 80r of the tray 80 into the concave portion 80r. These holes 80a and 80b extend in the direction 80A or 80B. Since an elastic force is applied to the positioning structure 90 in the direction 80B, the positioning pins 91 and 92 are located at the frontmost portions of the holes 80a and 80b, respectively.

The positioning structure 90 engages with an actuator 99, which is interlocked with the slider 81 so as to be movable in the direction 80A or 80B. The actuator 99 includes a contacting portion 99a that contacts with the slider 81. When the slider 81 moves a predetermined distance in the direction 80A, the slider 81 contacts with the contacting portion 99a, thereby moving the actuator 99 in the direction 80A. As a result, the positioning structure 90 also moves in the direction 80A so that the positioning pins 91 and 92 are located at the rearmost portions of the holes 80a and 80b (i.e., closest to the deep part of the disk drive 305).

The tray 80 is normally stored inside the disk drive 305 and located under the roof 70. In loading a cartridge into the disk drive 305, a tray moving mechanism (not shown) draws the tray 80 out of the disk drive 305 as shown in FIG. 22. When the user gives an instruction to the disk drive 305 after having mounted the cartridge on the concave portion 10r of the tray 80, the tray moving mechanism pulls in the tray 80 along the guide grooves 74a and 74b of the roof 70.

At this point in time, the opener/closer 112c of the first cartridge 105 or the opener/closer 212c of the second or third cartridge 205 or 215 engages with the shutter opener/closer 77. As the tray 80 is pulled in, the shutter opener/closer 77 also moves along the guide groove 70c to open the shutter(s) of the cartridge gradually. When the tray 80 is completely stored inside the disk drive 305, the shutter(s) of the cartridge is/are also fully opened. Thereafter, the traverse chassis 20 is raised to mount the disk 10 inside the cartridge on the turntable 30b of the spindle motor 30. Also, if necessary, the clamper 71 is lowered. The operation of the clamper 71 will be described in detail later.

In this preferred embodiment, each of the first, second and third cartridges 105, 205 and 215 includes the opener/closer on the same side surface. Alternatively, these cartridges 105, 205 and 215 may include their openers/closers at mutually different positions and the disk drive 305 may include a shutter opener/closer that can operate on any of the openers/closers of these cartridges. Also, the timing to open or close the shutter(s) of any of these cartridges may be changed with the type of the disk stored in the cartridge.

In the disk drive 305, to mount the disk 10 inside the cartridge on the turntable 30b of the spindle motor 30 just as intended, the cartridge needs to be accurately positioned both on an X-Y plane that is parallel to the signal recording side 10A of the disk 10 and in the thickness direction thereof (i.e., in the Z direction). As will be described in detail below, the disk drive 305 can roughly position the cartridge on the X-Y plane and in the Z direction when the cartridge is mounted on the tray 80 and precisely position it on the X-Y plane and in the Z direction when the traverse chassis 20 is raised.

Three types of disks, from/on which a signal should be read and/or written in compliance with mutually different sets of standards, are stored in the first, second and third cartridges 105, 205 and 215, respectively. Thus, the optical pickup 40, spindle motor 30 and controllers (not shown) are compatible with each of these different sets of standards.

Next, it will be described how to load the first, second or third cartridge 105, 205 or 215 into this disk drive 305.

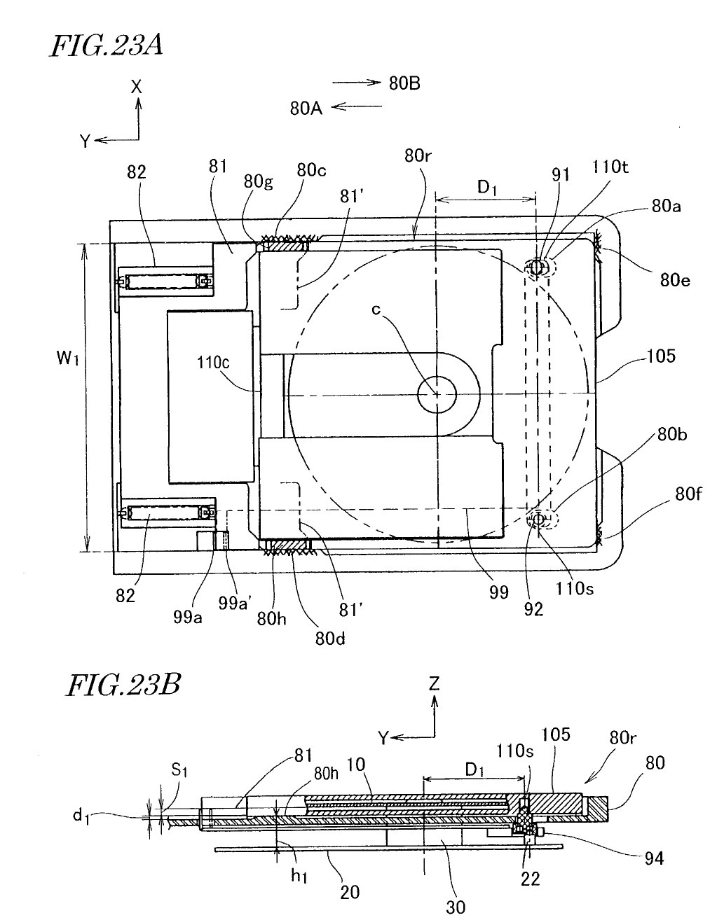

FIGS. 23A and 23B are respectively a plan view illustrating a state where the first cartridge 105 has been loaded into the disk drive 305 and a cross-sectional view thereof as viewed parallelly to the inserting direction. The side surfaces of the tray 80 that define the concave portion 80r include a first set of receiving surfaces 80c, 80d, 80e and 80f. The receiving surfaces 80c and 80d contact with the side surfaces of the first cartridge 105, which are parallel to the inserting direction, thereby defining the position of the first cartridge 105 in the X direction. On the other hand, the receiving surfaces 80e and 80f contact with the front side of the first cartridge 105, thereby defining the position of the first cartridge 105 in the Y direction. The distance between the receiving surfaces 80c and 80d is W₁, which is equal to the width of the first cartridge 105. Bearing surfaces 80g and 80h are provided near the receiving surfaces 80c and 80d to receive the back surface 110b of the first cartridge 105. The bearing surfaces 80g and 80h are higher than the bottom of the concave portion 80r of the tray 80 by d₁, which is set equal to the difference between S₂ of the second cartridge 205 and S₁ of the first cartridge 105. That is to say, d₁, S₁ and S₂ satisfy the equation d₁=S₂−S₁.

While the first cartridge 105 has not been mounted on the tray 80 yet, an elastic force is applied from the springs 82 to the slider 81 in the direction 80B. Thus, the slider 81 is located at the position indicated by the dashed lines 81′ in FIG. 23A. In that state, the positioning pins 91 and 92 are located at the frontmost portions of the holes 80a and 80b, respectively, and the contacting portion 99a of the actuator 99 is located at the position indicated by the dashed line 99a′.

After the tray 80 has been drawn out of the disk drive 305, the first cartridge 105 is introduced into the concave portion 80r of the tray 80 while getting the slider 81 pressed by the side surface of the first cartridge 105. When the slider 81 has moved a predetermined distance, the slider 81 will contact with the contacting portion 99a of the actuator 99. After that, the slider 81 moves along with the actuator 99. As the actuator 99 moves, the positioning structure 90 also moves and the positioning pins 91 and 92 thereof slide inside the holes 80a and 80b, respectively.

When the slider 81 moving reaches a point where the concave portion 80r can store the first cartridge 105 entirely, the first cartridge 105 is mounted on the concave portion 80r of the tray 80. Then, the first cartridge 105 contacts with the receiving surfaces 80c and 80d so as to have its position defined in the X direction. Also, since an elastic force is applied to the slider 81 in the direction 80B, the first cartridge 105 also contacts with the receiving surfaces 80e and 80f so as to have its position defined in the Y direction. In this manner, the position of the first cartridge 105 on an X-Y plane, which is parallel to the signal recording side 10A of the disk 10, is defined with respect to the tray 80.

The back surface 110b of the first cartridge 105 contacts with the bearing surfaces 80g and 80h. As shown in FIG. 23B, the distance between the back surface 110b of the first cartridge 105 and the signal recording side 10A of the disk 10, from/on which a signal is being read or written, is S₁. Accordingly, the distance between the bottom of the concave portion 80r and the signal recording side 10A is d₁+S₁. Since d₁, S₁ and S₂ satisfy the equation d₁=S₂−S₁ as described above, the distance between the bottom of the concave portion 80r and the signal recording side 10A is S₂.

Also, by this point in time, the positioning pins 91 and 92 have moved to their respective positions at which the positioning pins 91 and 92 can engage with the positioning holes 110t and 110s of the first cartridge 105, respectively. Thus, the respective tops of the positioning pins 91 and 92 are inserted into the positioning holes 110t and 110s of the first cartridge 105 and the bearing surfaces 91a and 92a of the positioning pins 91 and 92 contact with the back surface 110b of the first cartridge 105. The distance between the center of the disk 10 and the line that connects together the respective tops of the positioning pins 91 and 92 is D₁.

As described above, when the first cartridge 105 is mounted on the tray 80, the first cartridge 105 may be roughly positioned on the X-Y plane with respect to the tray 80. However, the tray 80 is drawn out of, or inserted into, the disk drive 305 by the tray moving mechanism (not shown) that cannot control the movement of the tray 80 so accurately. Accordingly, when the tray 80 is inserted into the disk drive 305, the position of the tray 80 with respect to the spindle motor 30 and the turntable 30b thereof might shift from its predetermined position.

For that reason, the fixing pins 21 and 22 are provided for the traverse chassis 20, to which the spindle motor 30 is secured, and are engaged with the positioning holes 91b and 92b or 91c and 92c of the positioning pins 91 and 92, respectively. In this manner, the position of the first cartridge 105 is defined with respect to the spindle motor 30 and the turntable 30b.

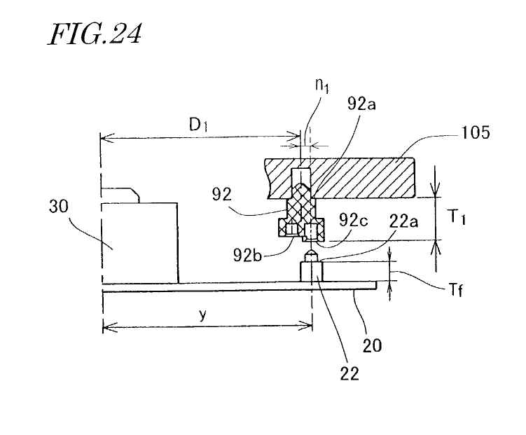

After the tray 80 has been inserted into the disk drive 305, the traverse chassis 20, to which the spindle motor 30 and the fixing pins 21 and 22 are secured, is raised in the Z direction as shown in FIG. 23B. At this point in time, the top of the fixing pin 22 is located under the positioning hole 92c of the positioning pin 92 as shown in FIG. 24. Accordingly, when the traverse chassis 20 is raised in the Z direction, the top of the fixing pin 22 is inserted into the positioning hole 92c. In the same way, the top of the fixing pin 21 is inserted into the positioning hole 91c. As also shown in FIG. 24, the distance between the bearing surface 92a of the positioning pin 92 that receives the back surface 110b of the first cartridge 105 and another bearing surface thereof that surrounds the positioning hole 92c and the distance between the bearing surface 91a of the positioning pin 91 that receives the back surface 110b of the first cartridge 105 and another bearing surface thereof that surrounds the positioning hole 91c are both T₁. The bearing surfaces 21a and 22a of the fixing pins 21 and 22 have a height T_{f}.

The distance between the center of the spindle motor 30 and the line that connects together the respective centers of the fixing pins 21 and 22 as measured in the Y direction is y. And the distance between the center of the top of the positioning pin 91 or 92 and the center of its positioning hole 91c or 92c is n₁. Accordingly, D₁, n₁ and y satisfy the equation y=D₁+n₁.

The tops of the fixing pins 21 and 22 and the bottoms of the positioning holes 91c and 92c are preferably tapered as shown in FIG. 24. This is because in that case, even if the tops of the fixing pins 21 and 22 slightly shifted from the positioning holes 91c and 92c of the positioning pins 91 and 92, the fixing pins 21 and 22 would engage with the positioning holes 91c and 92c just as intended.

As shown in FIG. 23B, when the disk 10 is mounted on the turntable 30b of the spindle motor 30 by raising the traverse chassis 20, the top of the fixing pin 22 has been fully inserted into the positioning hole 92c and the positioner 93 including the positioning pin 92 has been separated from the supporter 94. Also, the bearing surface 92a of the positioning pin 92 is higher than the bottom of the concave portion 80r of the tray 80 by d₁. In the same way, the top of the fixing pin 21 has also been fully inserted into the positioning hole 91c and the bearing surface 91a of the positioning pin 91 is higher than the bottom of the concave portion 80r of the tray 80 by d₁. In this case, the distance h₁ between the upper surface of the traverse chassis 20 and the back surface 110b of the first cartridge 105 is given by h₁=T₁+T_{f} as shown in FIGS. 23 and 24.

The back surface 110b of the first cartridge 105 is supported by the bearing surfaces 80g and 80h of the concave portion 80r and the bearing surfaces 91a and 92a of the positioning pins 91 and 92. By this point in time, the disk 10 that is stored in the first cartridge 105 has been accurately mounted on the turntable 30b of the spindle motor 30 so that the optical pickup 40 can read or write a signal from/onto the disk 10. In this manner, the position of the first cartridge 105 in the Z direction is defined.

To eject the first cartridge 105 from the disk drive 305, an eject instruction is given to the disk drive 305, and the traverse chassis 20 is lowered responsive to the instruction. Thereafter, the tray 80 is drawn out of the disk drive 305 to a point where the user can remove the first cartridge 105 from the disk drive 305.

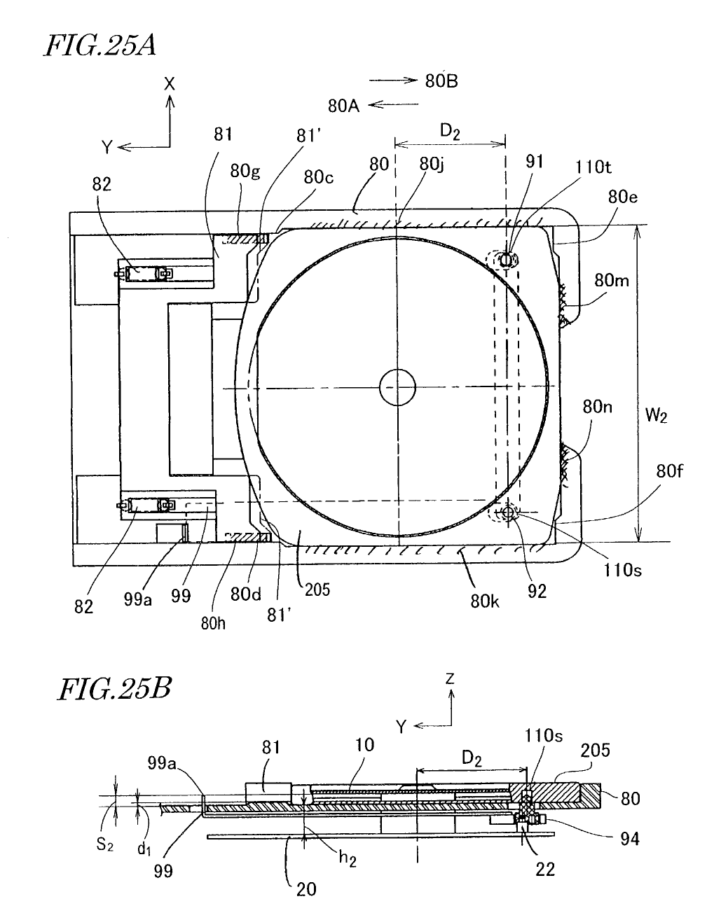

FIGS. 25A and 25B are respectively a plan view illustrating a state where the second cartridge 205 has been loaded into the disk drive 305 and a cross-sectional view as viewed parallelly to the inserting direction. The side surfaces of the tray 80 that define the concave portion 80r include a second set of receiving surfaces 80j, 80k, 80m and 80n. The receiving surfaces 80j and 80k contact with the side surfaces of the second cartridge 205, which are parallel to the inserting direction, thereby defining the position of the second cartridge 205 in the X direction. On the other hand, the receiving surfaces 80m and 80n contact with the front side of the second cartridge 205, thereby defining the position of the second cartridge 205 in the Y direction. The distance between the receiving surfaces 80j and 80k is W₂, which is equal to the width of the second cartridge 205.

As described above, while the second cartridge 205 has not been mounted on the tray 80 yet, the slider 81 is located at the position indicated by the dashed lines 81′ in FIG. 25A. In that state, the positioning pins 91 and 92 are located at the frontmost portions of the holes 80a and 80b, respectively, and the contacting portion 99a of the actuator 99 is located at the position indicated by the dashed line 99a′.

After the tray 80 has been drawn out of the disk drive 305, the second cartridge 205 is introduced into the concave portion 10r of the tray 80 while getting the slider 81 pressed by the side surface of the second cartridge 205. As shown in FIG. 25A, if the slider 81 is moved a little, a space that is broad enough to mount the second cartridge 205 can be provided. At this point in time, the slider 81 has not contacted with the contacting portion 99a of the actuator 99 yet. Thus, the positioning structure 90 does not move.

In such a state, the second cartridge 205 is mounted on the concave portion 80r of the tray 80. Then, the second cartridge 205 contacts with the receiving surfaces 80j and 80k so as to have its position defined in the X direction. Also, since an elastic force is applied to the slider 81 in the direction 80B, the second cartridge 205 contacts with the receiving surfaces 80m and 80n so as to have its position defined in the Y direction, too. In this manner, the position of the second cartridge 205 on an X-Y plane that is parallel to the signal recording side 10A of the disk 10 is defined with respect to the tray 80. In this state, the center of the disk 10 that is stored in the second cartridge 205 is located at the same position as the center of the disk 10 when the first cartridge 105 is mounted on the tray 80.

In this case, the second cartridge 205 contacts with none of the first set of receiving surfaces 80c, 80d, 80e and 80f. In other words, the receiving surfaces 80c, 80d, 80e and 80f are provided at such positions as not to contact with the second cartridge 205. The second cartridge 205 does not contact with the bearing surface 80g or 80h, either. Instead, the back surface 210b of the second cartridge 205 is supported by the bottom of the concave portion 80r of the tray 80. That is to say, the bottom of the concave portion 80r may be used as a second bearing surface to support the second cartridge 205 thereon. Since the back surface 210b of the second cartridge 205 is in contact with the bottom of the concave portion 80r of the tray 80, the distance between the bottom of the concave portion 80r and the signal recording side 10A of the disk 10, from/on which a signal is being read or written, is S₂ as shown in FIG. 25B.

Also, by this point in time, the positioning pins 91 and 92 have moved to their respective positions at which the positioning pins 91 and 92 can engage with the positioning holes 210t and 210s of the second cartridge 205, respectively. Thus, the respective tops of the positioning pins 91 and 92 are inserted into the positioning holes 210t and 210s of the second cartridge 205 and the bearing surfaces 91a and 92a of the positioning pins 91 and 92 contact with the back surface 210b of the second cartridge 205. The distance between the center of the disk 10 and the line that connects together the respective tops of the positioning pins 91 and 92 is D₂.

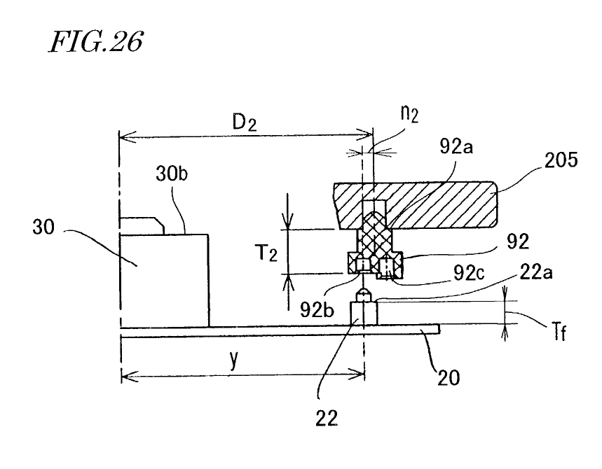

Subsequently, after the tray 80 has been inserted into the disk drive 305, the traverse chassis 20, to which the spindle motor 30 and the fixing pins 21 and 22 are secured, is raised in the Z direction as shown in FIG. 25B. At this point in time, the top of the fixing pin 22 is located under the positioning hole 92b of the positioning pin 92 as shown in FIG. 26. Accordingly, when the traverse chassis 20 is raised in the Z direction, the top of the fixing pin 22 is inserted into the positioning hole 92b. In the same way, the top of the fixing pin 21 is inserted into the positioning hole 91b. As also shown in FIG. 26, the distance between the bearing surface 92a of the positioning pin 92 that receives the back surface 210b of the second cartridge 205 and another bearing surface thereof that surrounds the positioning hole 92b and the distance between the bearing surface 91a of the positioning pin 91 that receives the back surface 210b of the second cartridge 205 and another bearing surface thereof that surrounds the positioning hole 91b are both T₂. T₂ is defined so as to satisfy the relationship T₁−T₂=S₂−S₁=d₁. The bottoms of the positioning holes 91b and 92b are also preferably tapered for the same reasons as described above.

The distance between the center of the top of the positioning pin 91 or 92 and the center of the positioning hole 91b or 92b is n₂. Accordingly, D₂, n₂ and y satisfy the relationship D₂=y+n₂. As shown in FIG. 24, D₁, n₁ and y satisfy the relationship y=D₁+n₁. Thus, D₁−D₂=n₁+n₂. That is to say, the pitch between the positioning holes 91b and 91c or 92b and 92c is equal to the difference between D₁ and D₂.

As shown in FIG. 25B, when the disk 10 is mounted on the turntable 30b of the spindle motor 30 by raising the traverse chassis 20, the top of the fixing pin 22 has been fully inserted into the positioning hole 92b. Also, the bearing surface 92a of the positioning pin 92 is as high as the bottom of the concave portion 80r of the tray 80. In the same way, the top of the fixing pin 21 has also been fully inserted into the positioning hole 91b. In this case, the distance h₂ between the upper surface of the traverse chassis 20 and the back surface 210b of the second cartridge 205 is given by h₂=T₂+T_{f} as shown in FIGS. 25B and 26.

Thus, the back surface 210b of the second cartridge 205 is supported by the bottom of the concave portion 80r and the bearing surfaces 91a and 92a of the positioning pins 91 and 92. By this point in time, the disk 10 that is stored in the second cartridge 205 has been accurately mounted on the turntable 30b of the spindle motor 30 so that the optical pickup 40 can read or write a signal from/onto the disk 10. In this manner, the position of the second cartridge 205 in the Z direction can be defined.

To eject the second cartridge 205 from the disk drive 305, an eject instruction is given to the disk drive 305, and the traverse chassis 20 is lowered responsive to the instruction. Thereafter, the tray 80 is drawn out of the disk drive 305 to a point where the user can remove the second cartridge 205 from the disk drive 305.

The third cartridge 215 may be positioned on the X-Y plane and in the Z direction inside the disk drive 305 in the same way as the second cartridge 205. The reason is as follows. The difference between the second and third cartridges 205 and 215 lies in the upper surface structure thereof as described above. However, the upper surface structure of a cartridge has nothing to do with the positioning of the cartridge inside the disk drive 305.

In mounting the cartridge on the tray 80 of the disk drive 305, the bearing surfaces 80g and 80h to support the first cartridge 105 thereon are not located under the second cartridge 205 but just under the first cartridge 105 as described above. Also, the bearing surfaces 80g and 80h are higher than the bottom of the concave portion 80r that supports the second cartridge 205 thereon. Accordingly, the first cartridge 105 is supported by the bearing surfaces 80g and 80h at a vertical level higher than that of the bottom of the concave portion 80r. On the other hand, the second cartridge 205 is supported by the bottom of the concave portion 80r at a vertical level lower than that of the bearing surfaces 80g and 80h. That is to say, the first and second cartridges 105 and 205 having mutually different planar shapes can be supported by the tray 80 differently so that their back surfaces 110b and 210b are located at two different vertical levels near the window thereof.

Also, the actuator 99 that is interlocked with the slider 81 moves the positioning structure 90 to get the first or second cartridge 105 or 205 supported on the bearing surfaces 91a and 92a of the positioning pins 91 and 92 included in the positioning structure 90. Each of the positioning pins 91 and 92 includes the positioning holes 91b and 91c or 92b and 92c at mutually different vertical levels as measured from the bearing surface 91a or 92a thereof. Accordingly, by getting the fixing pins 21 and 22 of the traverse chassis 20 selectively engaged with the positioning holes 91b and 92b or 91c and 92c, the height of the bearing surfaces 91a and 92a of the positioning pins 91 and 92 can be adjusted. Thus, the positioning pins 91 and 92 can be moved by the actuator 99, which moves a different distance according to the shape of the cartridge loaded, so that the bearing surfaces 91a and 92a to support the cartridge thereon move to one of the two vertical levels.

By using these two supporting structures, multiple types of cartridges can be supported at mutually different vertical levels according to their shapes. In this preferred embodiment, the distance between the bottom of the concave portion 80r of the tray 80 and the signal recording side 10A of the disk 10, which is stored in the cartridge to read or write a signal therefrom or thereon, is always S₂ irrespective of the shape of the cartridge loaded. That is to say, no matter whether the cartridge loaded is the first cartridge 105 or the second cartridge 205, the signal recording side 10A of the disk 10 is always held at the same vertical level. In other words, the back surface of the cartridge loaded has its vertical level adjusted according to the cartridge shape so that the signal recording side 10A of the disk 10, from/on which a signal is being read or written, is always located at the same vertical level irrespective of the type of the cartridge loaded.

On the other hand, by using the various receiving surfaces included in the side surfaces of the concave portion 80r of the tray 80, the first or second cartridge 105 or 205 can be positioned on a plane parallel to the signal recording side 10A of the disk 10 so that the center of the disk 10 is aligned with a predetermined position. However, the cartridge sometimes cannot be positioned accurately enough inside the disk drive 305 just by using the tray 80. For that reason, in this preferred embodiment, the positioning structure 90 is additionally provided for the tray 80 and moved by the actuator 99 that moves a different distance according to the shape of the cartridge loaded (i.e., depending on whether the cartridge loaded is the first cartridge 105 or the second cartridge 205). To accurately position the cartridge loaded into the disk drive 305, first, the positioning pins 91 and 92 of the positioning structure 90 are inserted into the positioning holes 110s and 110t of the first cartridge 105 or the positioning holes 210s and 210t of the second cartridge 205 to define the position of the cartridge inside the tray 80.

Next, the tray 80 is inserted into the disk drive 305 and then the traverse chassis 20 is raised to insert the fixing pins 21 and 22 of the traverse chassis 20 into the positioning holes 91b and 92b or 91c and 92c of the positioning pins 91 and 92. In this case, the fixing pins 21 and 22 are secured to the traverse chassis 20, and their positions do not change no matter whether the cartridge loaded is the first cartridge 105 or the second cartridge 205. However, the pitch between the positioning holes 91b and 91c at the bottom of the positioning pin 91 or the pitch between the positioning holes 92b and 92c at the bottom of the positioning pin 92 is equal to the difference between the distance D₁ from the center of the disk 10 to the line that connects together the respective centers of the positioning holes 110s and 110t of the first cartridge 105 and the distance D₂ from the center of the disk 10 to the line that connects together the respective centers of the positioning holes 210s and 210t of the second cartridge 205. It depends on the location of the positioning structure 90 as defined by the actuator 99, which moves a different distance according to the shape of the cartridge loaded, whether the fixing pins 21 and 22 should be inserted into the positioning holes 91b and 92b or the positioning holes 91c and 92c.

As a result of the movement of the positioning structure 90, either the positioning holes 91b and 92b or 91c and 92c on the bottoms of the positioning pins 91 and 92 of the positioning structure 90 are located over the fixing pins 21 and 22. That is to say, although the multiple types of cartridges have their positioning holes at mutually different pairs of locations, the positioning holes 91b and 92b or 91c and 92c to be engaged with the fixing pins 21 and 22 are located at the same pair of positions irrespective of the type of the cartridge. This is because the positioning structure 90 positions the cartridge loaded adaptively. Accordingly, by using the fixing pins 21 and 22 provided on the traverse chassis 20, the disk 10 that is stored in the cartridge loaded can be accurately positioned with respect to the spindle motor 30.

In this manner, by using the side surface structure of the concave portion 80r of the tray 80, the positioning structure 90, and the fixing pins 21 and 22 in combination, any of multiple types of cartridges with mutually different shapes can be accurately positioned according to its shape on a plane parallel to the disk stored in the cartridge.

In the preferred embodiment described above, the widths W₁ and W₂ of the first and second cartridges 105 and 205 and the distances L₁, L₂, M₁ and M₂ between the center of the disk 10 and the side surfaces of the first or second cartridge 105 or 205 satisfy the following relationships: W₁<W₂, L₁>L₂ and M₁<M₂ as shown in FIGS. 17A and 19A. However, even if the cartridges to be loaded do not satisfy all of these relationships at the same time, an alternative tray can be used to define the position of the cartridge loaded on a plane parallel to the disk with the center of the cartridge aligned with that of the spindle motor.

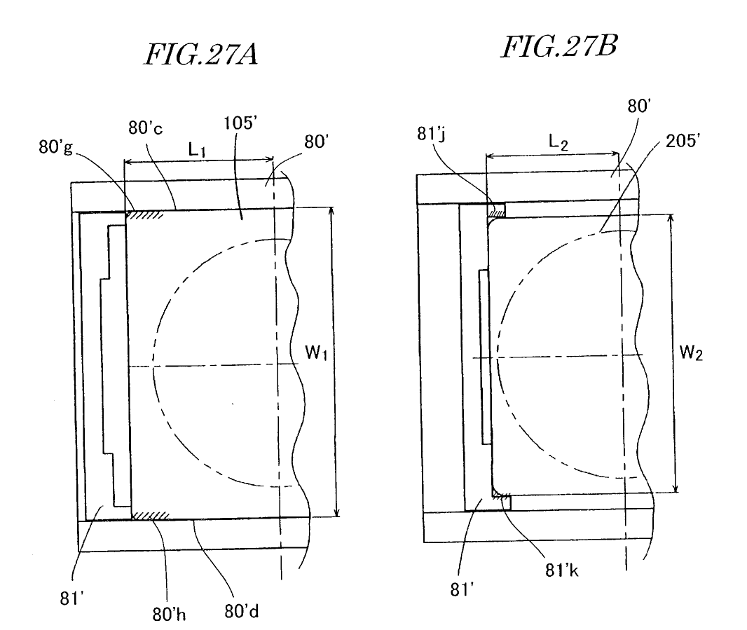

For example, first and second cartridges 105′ and 205′ that satisfy the relationships W₁>W₂ and L₁>L₂ may be positioned inside a tray 80′ as shown in FIGS. 27A and 27B. Specifically, to define the position of the first cartridge 105′ in the X direction, the side surfaces of the concave portion 80′r of the tray 80′ may include a first pair of receiving surfaces 80′c and 80′d as shown in FIG. 27A. Also, the bottom of the concave portion 80′r may include bearing surfaces 80′g and 80′h near the receiving surfaces 80′c and 80′d, respectively. On the other hand, to define the position of the second cartridge 205′ in the X direction, the slider 81′ may include a recess with a second pair of receiving surfaces 81′j and 81′k as shown in FIG. 27B. In that case, the bearing surfaces 80′g and 80′h do not contact with the second cartridge 205′.

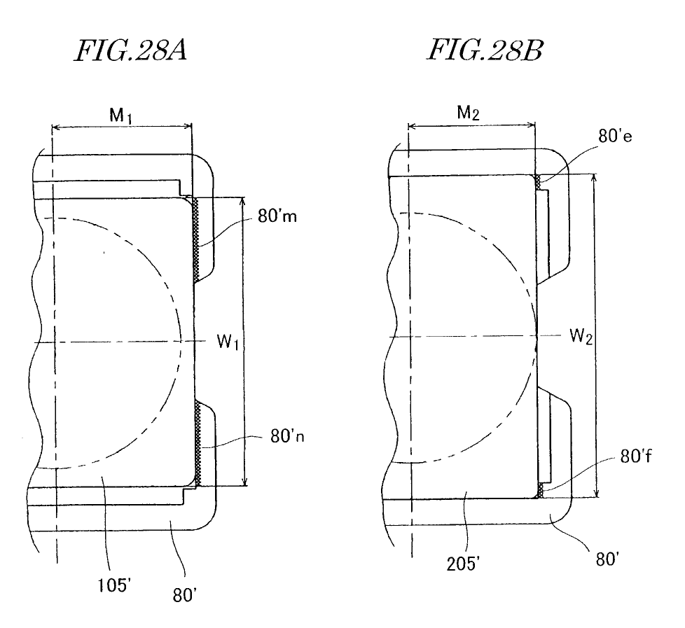

Also, first and second cartridges 105′ and 205′ that satisfy the relationships W₁<W₂ and M₁>M₂ may be positioned inside the tray 80′ as shown in FIGS. 28A and 28B. Specifically, to define the position of the first cartridge 105′ in the Y direction, the side surfaces of the concave portion 80′r of the tray 80′ may include a first pair of receiving surfaces 80′m and 80′n as shown in FIG. 28A. On the other hand, to define the position of the second cartridge 205′ in the Y direction, the side surfaces of the concave portion 80′r of the tray 80′ may include a second pair of receiving surfaces 80′e and 80′f as shown in FIG. 28B. In this case, since W₁<W₂, the second pair of receiving surfaces 80′e and 80′f can be provided outside of the first pair of receiving surfaces 80′m and 80′n. Then, any of these cartridges 105′ and 205′ can be mounted on the concave portion 80′r of the tray 80′ so that the center of the disk 10 stored in the first cartridge 105′ is aligned with that of the disk 10 stored in the second cartridge 205′.

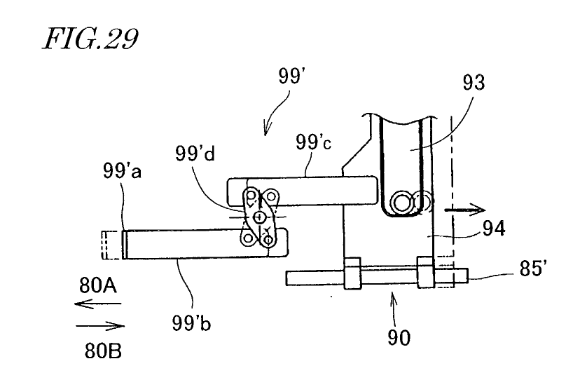

Furthermore, in the preferred embodiment described above, the first and second cartridges 105 and 205 satisfy the relationships L₁>L₂ and D₁<D₂ as shown in FIGS. 17A and 19A. Accordingly, the direction in which the actuator 99 moves along with the slider 81 is the same as the direction in which the positioning structure 90 moves. To realize a tray 80″ to mount first and second cartridges 105″ and 205″ that satisfy the relationships L₁>L₂ and D₁>D₂, an actuator 99′ such as that shown in FIG. 29 may be used. As shown in FIG. 29, the actuator 99′ includes first and second coupling portions 99′b and 99′c and a direction changer 99′d. The first coupling portion 99′b includes a contacting portion 99′a that contacts with the slider 81. One end of the second coupling portion 99′c is connected to the positioning structure 90. The direction changer 99′d may be implemented as a ring member and both ends thereof are coupled to the first and second coupling portions 99′b and 99′c in a rotatable state. Also, the center of the direction changer 99′d is secured to the tray 80″ (not shown).

In this actuator 99′, when the first coupling portion 99′b moves in the direction 80A, the second coupling portion 99′c moves in the direction 80B. Accordingly, by moving the slider 81 in the direction 80A, the positioning structure 90 can be moved in the direction 80B.

As described above, even if the widths W₁ and W₂ of two types of cartridges with mutually different shapes, the distances L₁, L₂, M₁ and M₂ between the center of the disk 10 and the side surfaces of the cartridge as measured in the inserting direction, and the distances D₁ and D₂ between the center of the disk and the line that connects together the respective centers of the positioning holes do not satisfy the relationships W₁<W₂, L₁>L₂, M₁<M₂ and D₁<D₂ at the same time, those cartridges can also be positioned on the tray so that the center of the disk stored in one of the cartridges is aligned with that of the disk stored in the other cartridge.

Next, it will be described how the disk drive 305 clamps the disk. Normally, in a disk drive, a disk is sandwiched and held between a clamper and a disk mount plane (e.g., a turntable) so as to rotate without fluttering after having been mounted on the disk mount plane.

In this preferred embodiment, although the first and second cartridges 105 and 205 include no clampers, the third cartridge 215 does include the clamper 220 inside. Accordingly, when the first or second cartridge 105 or 205 is loaded into the disk drive 305, the clamper 71 shown in FIG. 22 is used. On the other hand, when the third cartridge 215 is loaded into the disk drive 305, the clamper 71 of the disk drive 305 is lifted so as not to contact with the third cartridge 215.

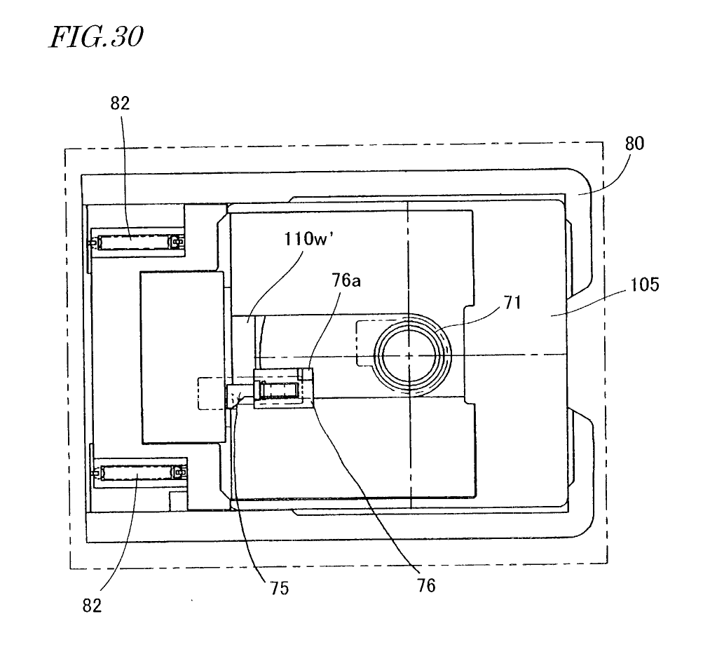

A clamping operation using the clamper 71 may or may not be performed depending on whether or not the disk is exposed at a predetermined position on the upper surface of the cartridge loaded when the shutter(s) of the cartridge is/are opened. This predetermined position is inside the opening of the cartridge loaded (which includes the clamper mount space). FIG. 30 is a plan view illustrating a state of the disk drive 305 into which the first cartridge 305 has been loaded. As shown in FIG. 30, the sensor lever 75 is provided on the roof 70 so as to be located over the window 110w′ on the upper surface 110a of the cartridge body 110 of the first cartridge 105.

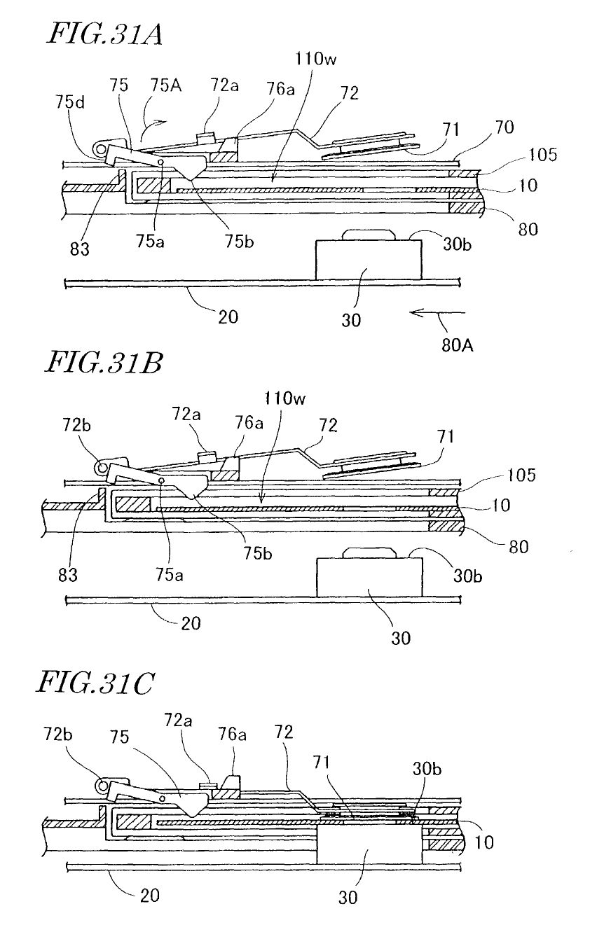

Hereinafter, it will be described with reference to FIGS. 31A through 31C how the clamping operation is performed when the first cartridge 105 is loaded into the disk drive 305. As shown in FIG. 31A, as the first cartridge 105 mounted on the tray 80 moves in the direction 80A, the shutter 112 is gradually opened and the window 110w′ is exposed little by little as already described with reference to FIG. 22. As shown in FIG. 31A, the sensor lever 75 rotates on the shaft 75a to the direction 75A so that one end 75d thereof does not protrude downward under the roof 70. Accordingly, the other end 75b of the sensor lever 75 is inserted into the window 110w′.

FIG. 31B illustrates a state where the tray 80 has been fully inserted into the disk drive 305. In this state, the stopper 76a of the sensor lever supporter 76 is not located under the convex portion 72a of the clamper supporter 72. Accordingly, as shown in FIG. 31C, after the tray 80 has been inserted, the traverse chassis 20 is raised to mount the disk 10 on the turntable 30b of the spindle motor 30. Meanwhile, the clamper supporter 72 is rotated on the shaft 72b, thereby lowering the clamper 71 toward the disk 10 and eventually sandwiching and holding the disk 10 between the clamper 71 and the turntable 30b.

In ejecting the first cartridge 105 from the disk drive 305, while the traverse chassis 20 is being lowered responsive to the eject instruction, the clamper supporter 72 is rotated on the shaft 72b to the opposite direction, thereby separating the clamper 71 from the disk 10.

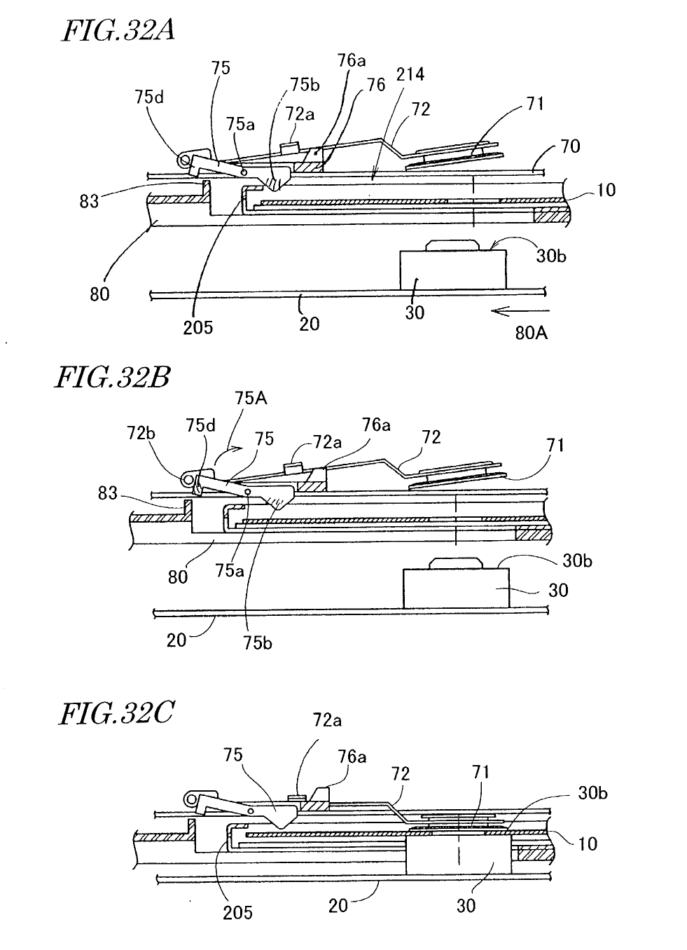

A similar clamping operation is performed when the second cartridge 205 is loaded into the disk drive 305. In the second cartridge 205, the upper surface 210a of its cartridge body 210 includes the window 214 that exposes one side of the disk 10 almost entirely. This window 214 is not covered with any shutter. Accordingly, as shown in FIG. 32A, when the second cartridge 205 mounted on the tray 80 is inserted into the disk drive 305, the end 75b of the sensor lever 75 is inserted into the window 214 on the upper surface 210a of the cartridge body 210. As in loading the first cartridge 105 into the disk drive 305, the stopper 76a of the sensor lever supporter 76 is not located under the convex portion 72a of the clamper supporter 72 as shown in FIG. 32B. Accordingly, as shown in FIG. 32C, after the tray 80 has been inserted, the traverse chassis 20 is raised to mount the disk 10 on the turntable 30b of the spindle motor 30. Meanwhile, the clamper supporter 72 is rotated on the shaft 72b, thereby lowering the clamper 71 toward the disk 10 and eventually sandwiching and holding the disk 10 between the clamper 71 and the turntable 30b.

In ejecting the second cartridge 205 from the disk drive 305, while the traverse chassis 20 is being lowered responsive to the eject instruction, the clamper supporter 72 is rotated on the shaft 72b to the opposite direction, thereby separating the clamper 71 from the disk 10.

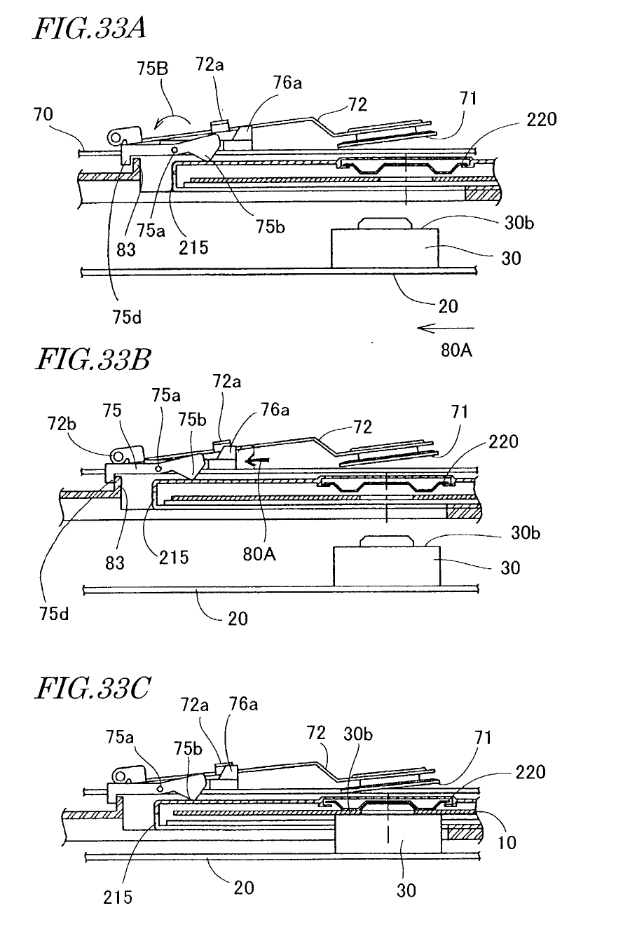

On the other hand, the third cartridge 215 includes no window on the upper surface 210a of its cartridge body 210. Accordingly, as shown in FIG. 33A, when the third cartridge 215 on the tray 80 is inserted into the disk drive 305, the end 75b of the sensor lever 75 contacts with the upper surface 210a of the cartridge body 210, thereby rotating the sensor lever 75 to the direction 75B. As a result, the other end 75d of the sensor lever 75 protrudes downward under the roof 70. As the tray 80 is inserted deeper into the disk drive 305, the end 75d of the sensor lever 75 soon engages with the protrusion 83 of the tray 80. Thus, as the tray 80 moves in the direction 80A, the sensor lever supporter 76 also moves in the same direction 80A.

As shown in FIG. 33B, when the tray 80 is fully inserted into the disk drive 305, the stopper 76a of the sensor lever supporter 76 is located under the convex portion 72a of the clamper supporter 72. Accordingly, as shown in FIG. 33C, after the tray 80 has been inserted, the traverse chassis 20 is raised to mount the disk 10 on the turntable 30b of the spindle motor 30. However, in this case, even if a rotating mechanism (not shown) tries to rotate the clamper supporter 72 on the shaft 72b in the meantime, the stopper 76a contacts with the convex portion 72a of the clamper supporter 72, thereby preventing the clamper 71 from lowering toward the disk 10. Nevertheless, since the third cartridge 215 includes the clamper 220, the disk 10 is sandwiched and held between the clamper 220 and the turntable 30b.

As described above, according to this preferred embodiment, it is determined first whether the upper surface of the cartridge loaded includes a window through which the clamper can pass. The clamper may be lowered selectively based on the result. Accordingly, no matter whether the cartridge being inserted includes a clamper or not, the disk drive 305 can always be loaded with the cartridge just as intended. Then, the disk 10 stored inside the cartridge can also be mounted appropriately so that a signal can be read or written from/on the disk 10.

As described above, the relationships between the widths W₁ and W₂ of two types of cartridges with mutually different shapes and the distances D₁ and D₂ from the center of the disk to the positioning holes and the relationships between the widths W₁ and W₂ of the cartridges and the distances S₁ and S₂ from the signal recording side of the disk to the back surface of the cartridges may be opposite to those defined for the first through fourth preferred embodiments of the present invention.

In the first through fifth preferred embodiments described above, the two positioning pins are moved so as to be engaged with one of the two or more pairs of positioning holes that are located at mutually different positions. Alternatively, two or more pairs of positioning pins may be provided for the two or more pairs of positioning holes at the different locations. In that case, a positioning structure for selectively protruding or retracting each of multiple pairs of positioning pins according to the type of the cartridge loaded may be used.

The disk drive according to each of the first through fourth preferred embodiments of the present invention described above includes a pair of regulating posts. Alternatively, the disk drive may include just one regulating post or three or more regulating posts.

Also, in the first through fifth preferred embodiments of the present invention described above, an optical disc is stored in the cartridge. However, a disk storage medium from/on which a signal is read and/or written by any other recording method (e.g., a magnetic disk) may be stored in the cartridge instead. In that case, the disk drive needs to include a read/write head that is compatible with the recording method applied to the disk.

Various preferred embodiments of the present invention described above provide a disk drive that can be appropriately loaded with any of multiple types of cartridges with mutually different shapes and that can read and/or write a signal from/on a disk that is stored in the cartridge loaded.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A disk drive that is loadable with any of first and second cartridges, each storing a disk having a signal recording side, wherein in performing read and/or write operation(s) on the disk, a distance between the signal recording side and a back surface of the first cartridge is different from a distance between the signal recording side and a back surface of the second cartridge, and wherein a planar shape of the first cartridge is different from that of the second cartridge, the disk drive comprising:
driving means including a mount plane on which the disk is mounted and rotated;
a read/write head for reading and/or writing a signal from/onto the signal recording side; and
a supporting structure for supporting the back surface of the first or second cartridge at a vertical level, which is changeable with respect to the mount plane of the driving means according to the shape of the cartridge loaded, so that the disk is mounted on the mount plane and that the signal is read and/or written from/on the disk.

2. The disk drive of claim 1, wherein the supporting structure includes first and second bearing surfaces that contact with only the back surface of the first cartridge and only the back surface of the second cartridge, respectively, and are located at mutually different vertical levels, and
wherein when the first or second cartridge is loaded into the disk drive, one of the first and second bearing surfaces at the higher vertical level is located under only the first cartridge or the second cartridge.

3. The disk drive of claim 2, wherein the supporting structure includes a regulating post having the first and second bearing surfaces, and
wherein the regulating post covers not only a region that is located under only the first or second cartridge but also a region that is located under each of the first and second cartridges when the first or second cartridge is loaded into the disk drive.

4. The disk drive of claim 1, further comprising an actuator that is movable differently according to the shape of the cartridge being loaded into the disk drive,
wherein the supporting structure includes a bearing surface that is interlocked with the actuator so as to shift vertically to one of two different levels and support the back surface of the first or second cartridge loaded as the actuator moves.

5. The disk drive of claim 1, wherein the supporting structure includes an actuator that is movable differently according to the shape of the cartridge being loaded into the disk drive and that has a bearing surface,
wherein the actuator moves in such a manner that when one of the first and second cartridges is loaded into the disk drive, the back surface of the cartridge loaded is supported by the bearing surface and that when the other cartridge is loaded into the disk drive, the back surface of the cartridge loaded does not contact with the bearing surface.

6. The disk drive of claim 5, wherein the supporting structure includes a reference plane that is defined at a predetermined vertical level with respect to the mount plane of the driving means, and
wherein when the other cartridge is loaded into the disk drive, the back surface of the cartridge loaded is supported by the reference plane.

7. The disk drive of claim 1, further comprising an actuator that is movable differently according to the shape of the cartridge being loaded into the disk drive,
wherein the supporting structure has a bearing surface, and
wherein the driving means and the read/write head are interlocked with the actuator so as to shift to different vertical levels with respect to the bearing surface of the supporting structure as the actuator moves.

8. A disk drive that is loadable with any of first and second cartridges, each storing a disk with a signal recording side and having a pair of positioning holes on the back surface thereof, wherein in performing read and/or write operation(s) on the disk, a distance between the center of the disk and a line that connects together the respective centers of the positioning holes of the first cartridge is different from a distance between the center of the disk and a line that connects together the respective centers of the positioning holes of the second cartridge, and wherein a planar shape of the first cartridge is different from that of the second cartridge, the disk drive comprising:
driving means including a mount plane on which the disk is mounted and rotated;
a read/write head for reading and/or writing a signal from/onto the signal recording side; and
a positioning structure including a pair of positioning pins that engages with the positioning holes of the first or second cartridge loaded so that the first or second cartridge loaded is positioned on a plane that is parallel to the signal recording side of the disk.

9. The disk drive of claim 8, further comprising an actuator that is movable differently according to the shape of the cartridge being loaded into the disk drive,
wherein the positioning pins are interlocked with the actuator so as to move along with the actuator.

10. The disk drive of claim 9, wherein as the actuator moves, the positioning pins move in a direction in which the first or second cartridge is loaded.

11. The disk drive of claim 9, wherein as the actuator moves, the positioning pins move vertically to a direction in which the first or second cartridge is loaded.

12. The disk drive of one of claims 8 to 11, wherein each of the positioning pins includes: a top to be inserted into associated one of the positioning holes; and a bearing surface that supports the back surface of the first or second cartridge loaded.

13. The disk drive of claim 10, wherein the positioning structure includes a positioning base that supports the positioning pins thereon, and
wherein the actuator moves the positioning base with respect to the driving means.

14. The disk drive of claim 8, further comprising an actuator that is movable differently according to the shape of the cartridge being loaded into the disk drive,
wherein the driving means and the read/write head are interlocked with the actuator so as to move with respect to the positioning pins as the actuator moves.

15. A disk drive that is loadable with any of first and second cartridges, each storing a disk with a signal recording side and having a pair of positioning holes on the back surface thereof, wherein in performing read and/or write operation(s) on the disk, a distance between the center of the disk and a line that connects together the respective centers of the positioning holes of the first cartridge is different from a distance between the center of the disk and a line that connects together the respective centers of the positioning holes of the second cartridge, and wherein a planar shape of the first cartridge is different from that of the second cartridge, the disk drive comprising:
driving means including a mount plane on which the disk is mounted and rotated;
a read/write head for reading and/or writing a signal from/onto the signal recording side; and
a positioning structure including a first pair of positioning pins that engages with the pair of positioning holes of the first cartridge loaded and a second pair of positioning pins that engages with the pair of positioning holes of the second cartridge so that the first or second cartridge loaded is positioned on a plane that is parallel to the signal recording side of the disk, the positioning structure selectively protruding the first or second pair of positioning pins by detecting the cartridge loaded as the first cartridge or the second cartridge according to the planar shape thereof.

16. A disk drive that is loadable with any of first and second cartridges, each storing a disk with a signal recording side and having a pair of positioning holes on the back surface thereof, wherein a planar shape of the first cartridge is different from that of the second cartridge, the disk drive comprising:
driving means including a mount plane on which the disk is mounted and rotated;
a read/write head for reading and/or writing a signal from/onto the signal recording side; and
a tray on which the first or second cartridge is mounted after having been positioned in such a manner that the center of the disk stored in the first cartridge mounted is aligned with that of the disk stored in the second cartridge mounted while the signal is read and/or written from/on the disk and which is used to insert or remove the first or second cartridge into/from the disk drive.

17. The disk drive of claim 16, wherein the tray includes a concave portion that stores at least a portion of each of the first and second cartridges, and
wherein the side surfaces of the concave portion include a first set of receiving surfaces that contacts with only side surfaces of the first cartridge and a second set of receiving surfaces that contacts with only side surfaces of the second cartridge.

18. The disk drive of claim 16, wherein in performing read and/or write operation(s) on the disk, a distance between the signal recording side and a back surface of the first cartridge is different from a distance between the signal recording side and a back surface of the second cartridge, and
wherein the tray includes first and second bearing surfaces that contact with only the back surface of the first cartridge and only the back surface of the second cartridge, respectively, and are located at mutually different vertical levels, and
wherein when the first or second cartridge is loaded into the disk drive, one of the first and second bearing surfaces at the higher vertical level is located under only the first cartridge or only the second cartridge.

19. The disk drive of claim 16, wherein in performing read and/or write operation(s) on the disk, a distance between the center of the disk and a line that connects together the respective centers of the positioning holes of the first cartridge is different from a distance between the center of the disk and a line that connects together the respective centers of the positioning holes of the second cartridge, and
wherein the tray includes:
an actuator that is movable differently according to the shape of the cartridge being loaded into the disk drive; and
a positioning structure that includes a pair of positioning pins and that is interlocked with the actuator so as to move in such a manner that the positioning pins thereof engage with the positioning holes of the first or second cartridge loaded.

20. The disk drive of claim 19, wherein each of the positioning pins includes: a top to be inserted into associated one of the positioning holes; and a bearing surface that contacts with the back surface of the first or second cartridge loaded.

21. The disk drive of claim 19, further comprising:
a traverse chassis that supports the driving means thereon; and
a pair of fixing pins that is provided for the traverse chassis,
wherein when the first or second cartridge being inserted on the tray reaches such a position that the center of the disk stored in the first or second cartridge is located over the center of the driving means, the traverse chassis is raised to mount the disk on the mount plane.

22. The disk drive of claim 21, wherein each of the positioning pins includes: first and second bottoms that are located at mutually different vertical levels with respect to the bearing surface; and first and second positioning holes that are provided on the first and second bottoms, respectively, and
wherein the actuator moves the positioning structure in such a manner that as the traverse chassis is raised, the fixing pins on the traverse chassis are selectively engaged with either the first positioning holes or the second positioning holes of the positioning pins.

23. A disk drive that is loadable with any of first and second cartridges, each storing a disk with a signal recording side, one of the first and second cartridges including an internal clamper, the other cartridge having a clamper mount space on the upper surface thereof, the disk drive comprising:
driving means including a mount plane on which the disk is mounted and rotated;
a read/write head for reading and/or writing a signal from/onto the signal recording side;
a clamper for sandwiching and holding the disk between the clamper and the mount plane of the driving means; and
sensor means for sensing whether the first or second cartridge loaded has the clamper mount space on the upper surface thereof,
wherein the clamper mount space includes a position at which the clamper of the disk drive is located in holding the disk thereon, and
wherein when the sensor means senses that the cartridge loaded has the clamper mount space, the disk drive mounts the clamper thereof onto the disk.

24. The disk drive of claim 23, further comprising a clamper supporter, which supports the clamper of the disk drive thereon and which is held so as to be rotatable at one end thereof, wherein when the sensor means senses that the cartridge loaded has the clamper mount space, the clamper supporter is rotated to mount the clamper of the disk drive onto the disk.
